(19) United States
(12) Patent Application Publication
(10) Pub. No.: US 2025/0159677 A1
(43) Pub. Date: May 15, 2025

(54) MULTIPLEXING TECHNIQUES FOR SIMULTANEOUS UPLINK CONTROL CHANNEL TRANSMISSIONS ON A SINGLE COMPONENT CARRIER

(71) Applicant: QUALCOMM Incorporated, San Diego, CA (US)

(72) Inventors: Mostafa KHOSHNEVISAN, San Diego, CA (US); Shaozhen GUO, Beijing (CN); Jing SUN, San Diego, CA (US); Xiaoxia ZHANG, San Diego, CA (US)

(21) Appl. No.: 18/838,172

(22) PCT Filed: Apr. 28, 2022
(86) PCT No.: PCT/CN2022/089898

§ 371 Date: Aug. 13, 2024

(51) Int. Cl. H04W 72/1268; H04B 7/06; H04L 5/00

(52) U.S. Cl. CPC H04W 72/1268; H04B 7/0626; H04L 5/0055

(57) ABSTRACT

Methods, systems, and devices for wireless communication are described. A user equipment (UE) may receive an indication to transmit first uplink control information (UCI) on a first physical uplink control channel (PUCCH) resource within a slot. The UE may also receive an indication to transmit second UCI on a second PUCCH resource within the slot. One or both of the first PUCCH resource or the second PUCCH resource may overlap with other PUCCH resources within the slot. The UE may multiplex the other PUCCH resources with the first PUCCH resource or the second PUCCH resource in accordance with UCI multiplexing rules. The multiplexing may result in a first one or more PUCCH resources and a second one or more PUCCH resources. The UE may transmit the first UCI on the first one or more PUCCH resources and the second UCI on the second one or more PUCCH resources.

### CROSS REFERENCE

The present application is a 371 national phase filing of International PCT Application No. PCT/CN2022/089898 by KHOSHNEVISAN et al., entitled “MULTIPLEXING TECHNIQUES FOR SIMULTANEOUS UPLINK CONTROL CHANNEL TRANSMISSIONS ON A SINGLE COMPONENT CARRIER,” filed Apr. 28, 2022, which is assigned to the assignee hereof, and which is expressly incorporated by reference in its entirety herein.

### FIELD OF TECHNOLOGY

The following relates to wireless communication, including multiplexing techniques for simultaneous uplink control channel transmissions on a single component carrier (CC).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support multiplexing techniques for simultaneous uplink control channel transmissions on a single component carrier (CC). Specifically, the described techniques may improve the efficiency of uplink control information (UCI) multiplexing procedures at a user equipment (UE). In accordance with aspects of the present disclosure, a UE may be scheduled to transmit first UCI on a first physical uplink control channel (PUCCH) resource within a slot and second UCI on a second PUCCH resource within the slot. The first UCI may include hybrid automatic repeat request (HARQ) acknowledgement (ACK) feedback associated with a first control resource set (CORESET) pool index, while the second UCI may include HARQ-ACK feedback associated with a second CORESET pool index. The UE may also be configured to transmit third UCI on a set of PUCCH resources within the slot. The third UCI may include a scheduling request or channel state information (CSI), among other examples. The UE may multiplex the first PUCCH resource with the set of PUCCH resources in accordance with a set of UCI multiplexing rules. The multiplexing may result in one or more PUCCH resources that are non-overlapping in time. Accordingly, the UE may transmit the second UCI on the second PUCCH and one or both of the first UCI or the third UCI on the one or more non-overlapping in time PUCCH resources.

A method for wireless communication at a UE is described. The method may include receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index, receiving a control signal that schedules transmission of third UCI on a first one or more uplink control channel resources within the slot, where the third UCI includes scheduling information or CSI, multiplexing the first uplink control channel resource with the first one or more uplink control channel resources in accordance with one or more uplink multiplexing rules, where the multiplexing results in a second one or more uplink control channel resources within the slot, and transmitting the first UCI, the second UCI, and at least a portion of the third UCI in the slot based on the multiplexing.

An apparatus for wireless communication at a UE is described. The apparatus may include a processor, memory coupled with the processor, and one or more instructions stored in the memory and executable by the processor to cause the apparatus to, based at least in part on the one or more instructions: receive an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index, receive a control signal that schedules transmission of third UCI on a first one or more uplink control channel resources within the slot, where the third UCI includes scheduling information or CSI, multiplex the first uplink control channel resource with the first one or more uplink control channel resources in accordance with one or more uplink multiplexing rules, where the multiplexing results in a second one or more uplink control channel resources within the slot, and transmit the first UCI, the second UCI, and at least a portion of the third UCI in the slot based on the multiplexing.

Another apparatus for wireless communication at a UE is described. The apparatus may include means for receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index, means for receiving a control signal that schedules transmission of third UCI on a first one or more uplink control channel resources within the slot, where the third UCI includes scheduling information or CSI, means for multiplexing the first uplink control channel resource with the first one or more uplink control channel resources in accordance with one or more uplink multiplexing rules, where the multiplexing results in a second one or more uplink control channel resources within the slot, and means for transmitting the first UCI, the second UCI, and at least a portion of the third UCI in the slot based on the multiplexing.

A non-transitory computer-readable medium storing code for wireless communication at a UE is described. The code may include instructions executable by a processor to receive an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index, receive a control signal that schedules transmission of third UCI on a first one or more uplink control channel resources within the slot, where the third UCI includes scheduling information or CSI, multiplex the first uplink control channel resource with the first one or more uplink control channel resources in accordance with one or more uplink multiplexing rules, where the multiplexing results in a second one or more uplink control channel resources within the slot, and transmit the first UCI, the second UCI, and at least a portion of the third UCI in the slot based on the multiplexing.

In some examples of the method, apparatuses, and non-transitory computer-readable medium described herein, the second uplink control channel resource may be excluded from the multiplexing based on the second CORESET pool index having a fixed value.

In some examples of the method, apparatuses, and non-transitory computer-readable medium described herein, the second uplink control channel resource may be excluded from the multiplexing based on a time duration of the second uplink control channel resource starting prior to a time duration of the first uplink control channel resource.

In some examples of the method, apparatuses, and non-transitory computer-readable medium described herein, the second uplink control channel resource may be excluded from the multiplexing based on a time duration of the second uplink control channel resource starting after a time duration of the first uplink control channel resource.

In some examples of the method, apparatuses, and non-transitory computer-readable medium described herein, transmitting the first UCI, the second UCI, and at least a portion of the third UCI may include operations, features, means, or instructions for transmitting the second UCI on the second uplink control channel resource and transmitting one or both of the first UCI or the third UCI on the second one or more uplink control channel resources based on determining that the second uplink control channel resource and the second one or more uplink control channel resources may be non-overlapping in time.

In some examples of the method, apparatuses, and non-transitory computer-readable medium described herein, a first portion of the second one or more uplink control channel resources corresponds to the HARQ-ACK information associated with the first CORESET pool index, a first portion of the third UCI, or both and a second portion of the second one or more uplink control channel resources corresponds to a second portion of the third UCI.

In some examples of the method, apparatuses, and non-transitory computer-readable medium described herein, transmitting the first UCI, the second UCI, and at least a portion of the third UCI may include operations, features, means, or instructions for transmitting the second UCI on the second uplink control channel resource, transmitting one or both of the first UCI or the first portion of the third UCI on the first portion of the second one or more uplink control channel resources, and transmitting the second portion of the third UCI on the second portion of the second one or more uplink control channel resources based on determining that the second uplink control channel resource and the second portion of the second one or more uplink control channel resources may be non-overlapping in time.

Some examples of the method, apparatuses, and non-transitory computer-readable medium described herein may further include operations, features, means, or instructions for dropping the second portion of the second one or more uplink control channel resources based on determining that the second uplink control channel resource and the second portion of the second one or more uplink control channel resources at least partially overlap in time.

In some examples of the method, apparatuses, and non-transitory computer-readable medium described herein, transmitting the first UCI, the second UCI, and at least a portion of the third UCI may include operations, features, means, or instructions for transmitting the second UCI on the second uplink control channel resource, transmitting one or both of the first UCI or the first portion of the third UCI on the first portion of the second one or more uplink control channel resources, refraining from transmitting the second portion of the third UCI based on dropping the second portion of the second one or more uplink control channel resources, and transmitting a third portion of the third UCI on a third portion of the second one or more uplink control channel resources based on determining that the second uplink control channel resource and the third portion of the second one or more uplink control channel resources may be non-overlapping in time.

Some examples of the method, apparatuses, and non-transitory computer-readable medium described herein may further include operations, features, means, or instructions for multiplexing the second uplink control channel resource with the second portion of the second one or more uplink control channel resources based on determining that the second uplink control channel resource and the second portion of the second one or more uplink control channel resources at least partially overlap in time.

In some examples of the method, apparatuses, and non-transitory computer-readable medium described herein, transmitting the first UCI, the second UCI, and at least a portion of the third UCI may include operations, features, means, or instructions for transmitting the second UCI and the second portion of the third UCI on the second uplink control channel resource or a third uplink control channel resource that may be different from the second uplink control channel resource based on multiplexing the second uplink control channel resource with the second portion of the second one or more uplink control channel resources, transmitting one or both of the first UCI or the first portion of the third UCI on the first portion of the second one or more uplink control channel resources, and transmitting a third portion of the third UCI on a third portion of the second one or more uplink control channel resources based on determining that the second uplink control channel resource and the third portion of the second one or more uplink control channel resources may be non-overlapping in time.

Some examples of the method, apparatuses, and non-transitory computer-readable medium described herein may further include operations, features, means, or instructions for receiving a control message that indicates a separate HARQ-ACK feedback mode for the UE, where the second uplink control channel resource may be excluded from the multiplexing based on the separate HARQ-ACK feedback mode of the UE.

Some examples of the method, apparatuses, and non-transitory computer-readable medium described herein may further include operations, features, means, or instructions for receiving a control message that indicates simultaneous uplink control channel transmissions may be enabled for the UE, where transmitting the first UCI, the second UCI, and at least a portion of the third UCI may be based on the control message.

Some examples of the method, apparatuses, and non-transitory computer-readable medium described herein may further include operations, features, means, or instructions for receiving a control message that indicates a first one or more parameters associated with the first CORESET pool index and a second one or more parameters associated with the second CORESET pool index, where multiplexing the first uplink control channel resource with the first one or more uplink control channel resources may be based on the first one or more parameters.

In some examples of the method, apparatuses, and non-transitory computer-readable medium described herein, the first one or more parameters define rules for multiplexing CSI with HARQ-ACK information associated with the first CORESET pool index and the second one or more parameters define rules for multiplexing CSI with HARQ-ACK information associated with the second CORESET pool index.

Some examples of the method, apparatuses, and non-transitory computer-readable medium described herein may further include operations, features, means, or instructions for transmitting the first UCI, the second UCI, and at least a portion of the third UCI may be based on a capability of the UE to support simultaneous uplink control channel transmissions.

In some examples of the method, apparatuses, and non-transitory computer-readable medium described herein, the second one or more uplink control channel resources include PUCCH resources that may be non-overlapping in time.

A method for wireless communication at a UE is described. The method may include receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index, receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index, multiplexing the first set of multiple uplink control channel resources in accordance with one or more uplink multiplexing rules, where multiplexing the first set of multiple uplink control channel resources results in a first one or more uplink control channel resources, multiplexing the second set of multiple uplink control channel resources in accordance with the one or more uplink multiplexing rules, where multiplexing the second set of multiple uplink control channel resources results in a second one or more uplink control channel resources, and transmitting at least a portion of the first UCI on the first one or more uplink control channel resources and at least a portion of the second UCI on the second one or more uplink control channel resources.

An apparatus for wireless communication at a UE is described. The apparatus may include a processor, memory coupled with the processor, and one or more instructions stored in the memory and executable by the processor to cause the apparatus to, based at least in part on the one or more instructions: receive a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index, receive a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index, multiplex the first set of multiple uplink control channel resources in accordance with one or more uplink multiplexing rules, where multiplexing the first set of multiple uplink control channel resources results in a first one or more uplink control channel resources, multiplex the second set of multiple uplink control channel resources in accordance with the one or more uplink multiplexing rules, where multiplexing the second set of multiple uplink control channel resources results in a second one or more uplink control channel resources, and transmit at least a portion of the first UCI on the first one or more uplink control channel resources and at least a portion of the second UCI on the second one or more uplink control channel resources.

Another apparatus for wireless communication at a UE is described. The apparatus may include means for receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index, means for receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index, means for multiplexing the first set of multiple uplink control channel resources in accordance with one or more uplink multiplexing rules, where multiplexing the first set of multiple uplink control channel resources results in a first one or more uplink control channel resources, means for multiplexing the second set of multiple uplink control channel resources in accordance with the one or more uplink multiplexing rules, where multiplexing the second set of multiple uplink control channel resources results in a second one or more uplink control channel resources, and means for transmitting at least a portion of the first UCI on the first one or more uplink control channel resources and at least a portion of the second UCI on the second one or more uplink control channel resources.

A non-transitory computer-readable medium storing code for wireless communication at a UE is described. The code may include instructions executable by a processor to receive a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index, receive a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index, multiplex the first set of multiple uplink control channel resources in accordance with one or more uplink multiplexing rules, where multiplexing the first set of multiple uplink control channel resources results in a first one or more uplink control channel resources, multiplex the second set of multiple uplink control channel resources in accordance with the one or more uplink multiplexing rules, where multiplexing the second set of multiple uplink control channel resources results in a second one or more uplink control channel resources, and transmit at least a portion of the first UCI on the first one or more uplink control channel resources and at least a portion of the second UCI on the second one or more uplink control channel resources.

Some examples of the method, apparatuses, and non-transitory computer-readable medium described herein may further include operations, features, means, or instructions for receiving a control signal that indicates an association between CORESET pool indices and uplink control channel resources available for transmission of scheduling requests or CSI.

In some examples of the method, apparatuses, and non-transitory computer-readable medium described herein, multiplexing the first set of multiple uplink control channel resources may include operations, features, means, or instructions for selecting the first set of multiple uplink control channel resources for multiplexing based on an association between the first set of multiple uplink control channel resources and the first CORESET pool index.

In some examples of the method, apparatuses, and non-transitory computer-readable medium described herein, multiplexing the second set of multiple uplink control channel resources may include operations, features, means, or instructions for selecting the second set of multiple uplink control channel resources for multiplexing based on an association between the second set of multiple uplink control channel resources and the second CORESET pool index.

Some examples of the method, apparatuses, and non-transitory computer-readable medium described herein may further include operations, features, means, or instructions for receiving an indication of an association between unified transmission configuration indicator states and uplink control channel resources available for transmission of scheduling requests or CSI.

In some examples of the method, apparatuses, and non-transitory computer-readable medium described herein, multiplexing the first set of multiple uplink control channel resources may include operations, features, means, or instructions for selecting the first set of multiple uplink control channel resources for multiplexing based on an association between the first set of multiple uplink control channel resources and a unified transmission configuration indicator state corresponding to the first CORESET pool index.

In some examples of the method, apparatuses, and non-transitory computer-readable medium described herein, multiplexing the second set of multiple uplink control channel resources may include operations, features, means, or instructions for selecting the second set of multiple uplink control channel resources for multiplexing based on an association between the second set of multiple uplink control channel resources and a unified transmission configuration indicator state corresponding to the second CORESET pool index.

Some examples of the method, apparatuses, and non-transitory computer-readable medium described herein may further include operations, features, means, or instructions for receiving a control signal that indicates an association between closed loop indices and uplink control channel resources available for transmission of scheduling requests or CSI.

In some examples of the method, apparatuses, and non-transitory computer-readable medium described herein, multiplexing the first set of multiple uplink control channel resources may include operations, features, means, or instructions for selecting the first set of multiple uplink control channel resources for multiplexing based on an association between the first set of multiple uplink control channel resources and a closed loop index corresponding to the first CORESET pool index.

In some examples of the method, apparatuses, and non-transitory computer-readable medium described herein, multiplexing the second set of multiple uplink control channel resources may include operations, features, means, or instructions for selecting the second set of multiple uplink control channel resources for multiplexing based on an association between the second set of multiple uplink control channel resources and a closed loop index corresponding to the second CORESET pool index.

Some examples of the method, apparatuses, and non-transitory computer-readable medium described herein may further include operations, features, means, or instructions for receiving a control signal that indicates two or more CORESET pool indices configured for the UE, where multiplexing first set of multiple uplink control channel resources and the second set of multiple uplink control channel resources may be based on the control signal.

Some examples of the method, apparatuses, and non-transitory computer-readable medium described herein may further include operations, features, means, or instructions for receiving a control signal that indicates a separate HARQ-ACK feedback mode for the UE, where multiplexing the first set of multiple uplink control channel resources separate from the second set of multiple uplink control channel resources may be based on the control signal.

Some examples of the method, apparatuses, and non-transitory computer-readable medium described herein may further include operations, features, means, or instructions for receiving a control signal that indicates simultaneous uplink control channel transmissions may be enabled for the UE, where transmitting the first UCI and the second UCI may be based on the control signal.

Some examples of the method, apparatuses, and non-transitory computer-readable medium described herein may further include operations, features, means, or instructions for receiving a control signal that indicates a first one or more parameters associated with the first CORESET pool index and a second one or more parameters associated with the second CORESET pool index.

In some examples of the method, apparatuses, and non-transitory computer-readable medium described herein, multiplexing the first set of multiple uplink control channel resources may include operations, features, means, or instructions for multiplexing the first set of multiple uplink control channel resources in accordance with the first one or more parameters associated with the first CORESET pool index.

In some examples of the method, apparatuses, and non-transitory computer-readable medium described herein, multiplexing the second set of multiple uplink control channel resources may include operations, features, means, or instructions for multiplexing the second set of multiple uplink control channel resources in accordance with the second one or more parameters associated with the second CORESET pool index.

In some examples of the method, apparatuses, and non-transitory computer-readable medium described herein, the first one or more parameters define rules for multiplexing HARQ-ACK information and CSI associated with the first CORESET pool index and the second one or more parameters define rules for multiplexing HARQ-ACK information and CSI associated with the second CORESET pool index.

Some examples of the method, apparatuses, and non-transitory computer-readable medium described herein may further include operations, features, means, or instructions for transmitting the first UCI and the second UCI may be based on a capability of the UE to support simultaneous uplink control channel transmissions.

In some examples of the method, apparatuses, and non-transitory computer-readable medium described herein, transmitting the first UCI and the second UCI may include operations, features, means, or instructions for transmitting the first UCI on the first one or more uplink control channel resources and the second UCI on the second one or more uplink control channel resources based on determining that the first one or more uplink control channel resources and the second one or more uplink control channel resources at least partially overlap in time.

In some examples of the method, apparatuses, and non-transitory computer-readable medium described herein, the first one or more uplink control channel resources and the second one or more uplink control channel resources each include one or more PUCCH resources that may be non-overlapping in time.

### BRIEF DESCRIPTION OF THE DRAWINGS

FIGS. 1 and 2 illustrate examples of wireless communications systems that support multiplexing techniques for simultaneous uplink control channel transmissions on a single component carrier (CC) in accordance with one or more aspects of the present disclosure.

FIGS. 3 and 4 illustrate examples of resource diagrams that support multiplexing techniques for simultaneous uplink control channel transmissions on a single CC in accordance with one or more aspects of the present disclosure.

FIGS. 5A and 5B illustrate examples of resource diagrams that support multiplexing techniques for simultaneous uplink control channel transmissions on a single CC in accordance with one or more aspects of the present disclosure.

FIG. 6 illustrates an example of a resource diagram that supports multiplexing techniques for simultaneous uplink control channel transmissions on a single CC in accordance with one or more aspects of the present disclosure.

FIGS. 7 and 8 illustrate examples of process flows that support multiplexing techniques for simultaneous uplink control channel transmissions on a single CC in accordance with one or more aspects of the present disclosure.

FIGS. 9 and 10 show block diagrams of devices that support multiplexing techniques for simultaneous uplink control channel transmissions on a single CC in accordance with one or more aspects of the present disclosure.

FIG. 11 shows a block diagram of a communications manager that supports multiplexing techniques for simultaneous uplink control channel transmissions on a single CC in accordance with one or more aspects of the present disclosure.

FIG. 12 shows a diagram of a system including a device that supports multiplexing techniques for simultaneous uplink control channel transmissions on a single CC in accordance with one or more aspects of the present disclosure.

FIGS. 13 through 16 show flowcharts illustrating methods that support multiplexing techniques for simultaneous uplink control channel transmissions on a single CC in accordance with one or more aspects of the present disclosure.

### DETAILED DESCRIPTION

A user equipment (UE) may be capable of receiving physical downlink control channel (PDCCH) transmissions from multiple network entities. For example, the UE may receive a first PDCCH transmission (e.g., from a first transmission reception point (TRP)) within a first control resource set (CORESET), and may receive a second PDCCH transmission (e.g., from a second TRP) within a second CORESET. The UE may determine that the first PDCCH transmission is from the first TRP based on a CORESET pool index (also referred to herein as a resource pool index) associated with the first CORESET. Likewise, the UE may determine that the second PDCCH transmission is from the second TRP based on a CORESET pool index associated with the second CORESET. The first and second TRPs may transmit PDCCH transmissions in CORESETs associated with different resource pool indices such that the UE may distinguish to which TRPs the PDCCH transmissions correspond.

PDCCH transmissions from the first and second TRPs may, in some examples, schedule respective physical downlink shared channel (PDSCH) transmissions (e.g., to be transmitted by the first and second TRPs, respectively). In response to the PDSCH transmissions, the UE may transmit feedback (e.g., hybrid automatic repeat request (HARQ) acknowledgement (ACK) feedback) for the PDSCH transmissions using respective physical uplink control channel (PUCCH) resources. In some cases, these PUCCH resources may overlap in time with PUCCH resources on which the UE intends to transmit one or more scheduling requests, channel state information (CSI), or other uplink control information (UCI). In such cases, the UE may be configured with a set of rules for multiplexing (or dropping) the overlapping PUCCH resources. However, these multiplexing rules may not support simultaneous PUCCH transmissions on the same component carrier (CC).

In accordance with aspects of the present disclosure, if a UE is scheduled to transmit two instances of HARQ-ACK feedback associated with different CORESET pool indices on two PUCCH resources within a slot (or symbol, TTI, subframe, etc.), the UE may transmit both instances of HARQ-ACK feedback, even if the two PUCCH resources overlap in time, at least partially. If, for example, one or both of the PUCCH resources overlap with other PUCCH resources within the slot, the UE may exclude one of the two PUCCH resources (carrying HARQ-ACK feedback associated with a CORESET pool index) and multiplex the remaining PUCCH resource (carrying HARQ-ACK feedback associated with a different CORESET pool index) with the other PUCCH resources (carrying CSI or scheduling requests). This may result in two sets of PUCCH resources carrying HARQ-ACK feedback associated with different CORESET pool indices.

If, for example, PUCCH resources used for transmission of other UCI (e.g., CSI, scheduling requests) are also associated with respective CORESET pool indices, the UE may multiplex PUCCH resources that correspond to the same CORESET pool index. That is, the UE may combine (e.g., multiplex) PUCCH resources such that a first set of non-overlapping PUCCH resources are used for transmission of UCI (e.g., HARQ-ACK feedback, CSI, scheduling requests) associated with the first CORESET pool index and a second set of non-overlapping PUCCH resources are used for transmission of UCI associated with the second CORESET pool index. In some examples, the first set of non-overlapping PUCCH resources may overlap in time, at least partially, with the second set of non-overlapping PUCCH resources.

Aspects of the present disclosure may be implemented to realize one or more of the following advantages. The described techniques may enable a UE to perform UCI multiplexing operations with greater efficiency by providing the UE with a set of UCI multiplexing rules that support simultaneous PUCCH transmissions. For example, if the UE is scheduled to transmit first HARQ-ACK feedback (associated with a first CORESET pool index) and second HARQ-ACK feedback (associated with a second CORESET pool index) on different PUCCH resources within a slot, the UE may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE may attain higher throughput (by performing simultaneous or concurrent PUCCH transmissions), reduced latency (by dropping fewer PUCCH transmissions), and greater spectral efficiency (by multiplexing the HARQ-ACK feedback with other UCI).

Aspects of the disclosure are initially described in the context of wireless communications systems, resource diagrams, and process flows. Aspects of the disclosure are further illustrated by and described with reference to apparatus diagrams, system diagrams, and flowcharts that relate to multiplexing techniques for simultaneous uplink control channel transmissions on a single CC.

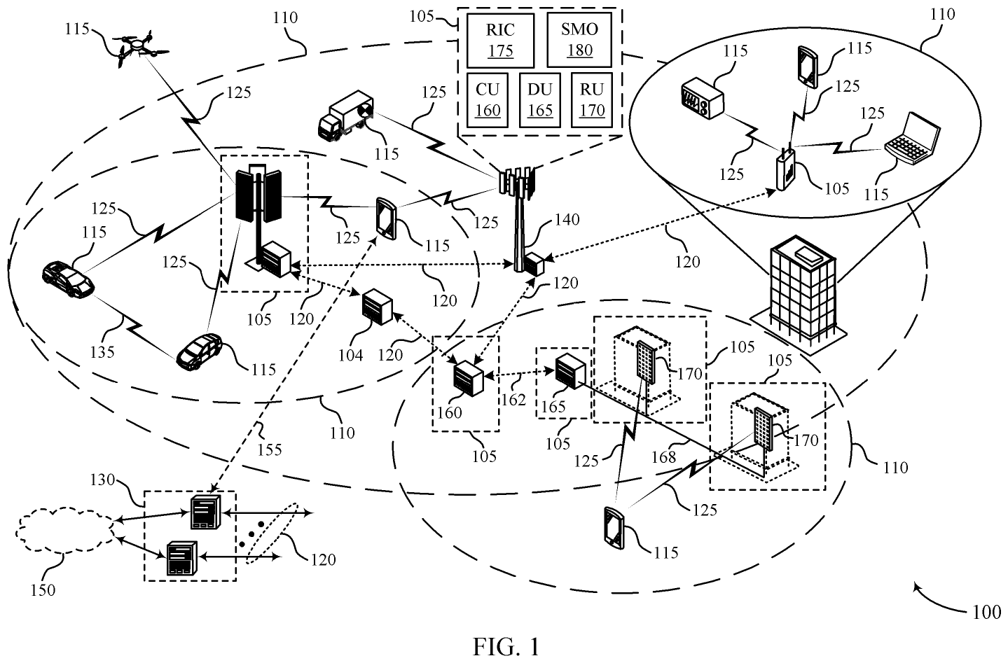

FIG. 1 illustrates an example of a wireless communications system 100 that supports multiplexing techniques for simultaneous uplink control channel transmissions on a single CC in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support multiplexing techniques for simultaneous uplink control channel transmissions on a single CC, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ represents a maximum supported subcarrier spacing, and N_{f} represents a maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of short TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or other functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with CCs operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. HARQ feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol within the slot. In some other examples, the device may provide HARQ feedback in a subsequent slot, or according to some other time interval.

Wireless communications system 100 may support simultaneous or concurrent PUCCH transmissions on a single CC for multiple downlink control information (DCI) communication schemes. One scenario for simultaneous or concurrent PUCCH transmission on a single CC is when a UE 115 is configured with a separate feedback reporting mode (e.g., ackNackFeedbackMode=separate). Some UCI multiplexing rules for overlapping PUCCH resources may not support simultaneous or concurrent PUCCH transmissions and may therefore not provide or define any rules for such scenarios. A UE 115 with simultaneous PUCCH transmission capabilities may be able to concurrently transmit two instances of HARQ-ACK feedback (as opposed to multiplexing the HARQ-ACK feedback together). PUCCH resources used for transmission of CSI or scheduling requests may, in some examples, be associated with a CORESET pool index (coresetPoolIndex) value. Thus, the UE 115 may be unable to determine which UCIs to multiplex such that all UCI scheduled within a slot can be transmitted on PUCCH resources that overlap in time (e.g., up to 2 PUCCH resources).

In accordance with aspects of the present disclosure, a UE 115 may receive an indication to transmit first UCI on a first PUCCH resource within a slot and second UCI on a second PUCCH resource within the slot. The first UCI may include HARQ-ACK feedback associated with a first CORESET pool index, while the second UCI may include HARQ-ACK feedback associated with a second CORESET pool index. The UE 115 may also receive a control signal that schedules transmission of third UCI on a set of PUCCH resources within the slot. The third UCI may include one or both of a scheduling request or CSI. The UE 115 may multiplex the first PUCCH resource with the set of PUCCH resources in accordance with a set of UCI multiplexing rules. Multiplexing the first PUCCH resource with the set of PUCCH resources may result in one or more PUCCH resources that are non-overlapping in time. Accordingly, the UE may transmit at least the first UCI on the one or more PUCCH resources, and may transmit the second UCI on the second PUCCH resource or a third PUCCH that is different from the second PUCCH resource.

Additionally, or alternatively, the UE 115 may receive a first set of control messages that schedule transmission of first UCI on a first set of multiple PUCCH resources within a slot, symbol, TTI, etc. The UE 115 may also receive a second set control messages that schedule transmission of second UCI on a second set of multiple PUCCH resources within the slot, symbol, TTI, etc. The first UCI and the second UCI may each include a scheduling request, HARQ-ACK feedback, CSI, or a combination thereof. The first set of multiple PUCCH resources may be associated with a first CORESET pool index, while the second set of multiple PUCCH resources may be associated with a second CORESET pool index. The UE 115 may multiplex the first set of multiple PUCCH resources in accordance with a set of UCI multiplexing rules, which may result in a first set of one or more PUCCH resources that are non-overlapping in time. The UE 115 may also multiplex the second set of multiple PUCCH resources in accordance with the set of UCI multiplexing rules, which may result in a second set of one or more PUCCH resources that are non-overlapping in time. The UE 115 may transmit at least a portion of the first UCI on the first set of one or more PUCCH resources, and may transmit at least a portion of the second UCI on the second set of one or more PUCCH resources.

Aspects of the wireless communications system 100 may be implemented to realize one or more of the following advantages. The techniques described with reference to FIG. 1 may enable a UE 115 to perform simultaneous PUCCH transmissions in accordance with a set of UCI multiplexing rules. For example, if the UE 115 is scheduled to transmit first HARQ-ACK feedback (associated with a first CORESET pool index) and second HARQ-ACK feedback (associated with a second CORESET pool index) on different PUCCH resources within a slot, the UE 115 may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time, at least partially. As a result, the UE 115 may attain higher throughput (by performing simultaneous PUCCH transmissions), reduced latency (by dropping fewer PUCCH transmissions), and greater spectral efficiency (by multiplexing the HARQ-ACK feedback with other UCI).

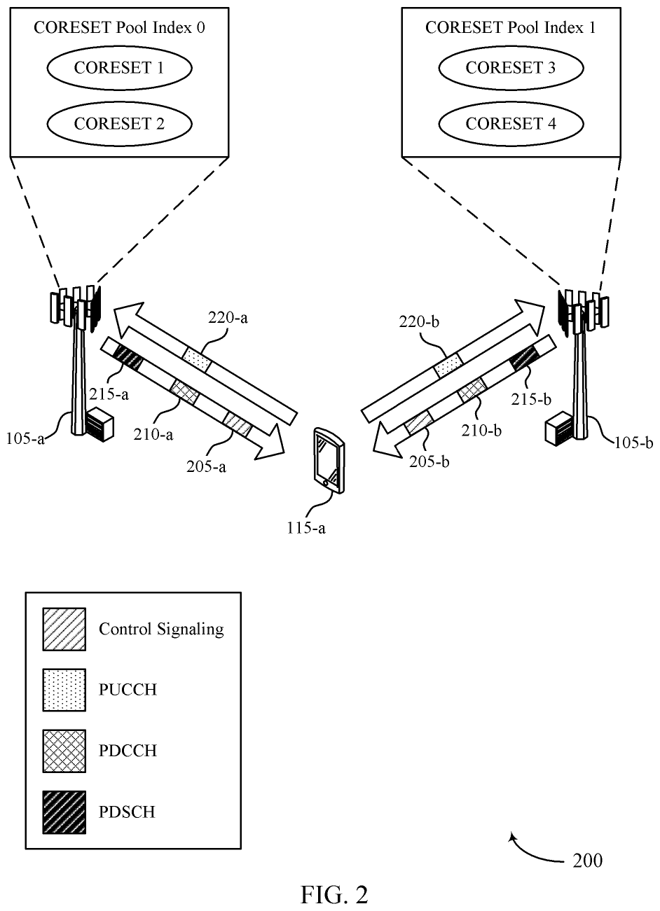

FIG. 2 illustrates an example of a wireless communications system 200 that supports multiplexing techniques for simultaneous uplink control channel transmissions on a single CC in accordance with one or more aspects of the present disclosure. The wireless communications system 200 may implement or be implemented by aspects of wireless communications system 100. For example, the wireless communications system 200 may include a UE 115-a, a network entity 105-a, and a network entity 105-b, which may be examples of corresponding devices described with reference to FIG. 1. In the wireless communications system 200, the network entities 105 may transmit downlink messages to the UE 115-a in accordance with a multi-DCI multi-TRP communication scheme. For example, the network entity 105-a (e.g., a first TRP) may transmit a first instance of DCI to the UE 115-a using resources associated with a first CORESET pool index, while the network entity 105-b (e.g., a second TRP) may transmit a second instance of DCI to the UE 115-b using resources associated with a second CORESET pool index.

The wireless communications system 200 may support multi-DCI multi-TRP transmissions from the network entities 105. For example, the UE 115-a may receive a first instance of DCI from the network entity 105-a on PDCCH resources 210-a and a second instance of DCI from the network entity 105-b on PDCCH resources 210-b. The first instance of DCI may schedule a downlink transmission from the network entity 105-a on PDSCH resources 215-a, while the second instance of DCI may schedule a downlink transmission from the network entity 105-b on PDSCH resources 215-b. The UE 115-a may differentiate which downlink messages correspond to which TRPs based on a CORESET pool index value.

Each CORESET (the UE 115-a may be configured with up to 5 different CORESETs) may be associated with a respective CORESET pool index. The value of a CORESET pool index can be 0 or 1. Thus, the UE 115-a may be configured with two groups of CORESETs. The UE 115-a may be unable to distinguish downlink transmissions from different TRPs without this CORESET pool index value. If the UE 115-a is configured (by a higher layer parameter such as PDCCH-Config) with two different CORESET pool index (coresetPoolIndex) values for CORESETs in an active BWP of a serving cell, the UE 115-a may be configured for multi-DCI multi-TRP communications on a single CC. The CORESET pool index value of a CORESET in which the UE 115-a receives an instance of DCI may determine which resources the UE 115-a uses for transmission of HARQ-ACK feedback associated with the instance of DCI.

For HARQ-ACK feedback in multi-DCI-based multi-TRP communication schemes, the UE 115-a may be configured with a joint feedback mode or a separate feedback mode. Joint transmission of ACK or negative acknowledgement (NACK) feedback on the same PUCCH resource may be applicable to some backhaul scenarios. A joint feedback mode (e.g., ackNackFeedbackMode=joint) may be configured for a cell group or a group of downlink CCs with HARQ-ACK feedback transmission on the same PUCCH cell. Separate ACK or NACK (A/N) feedback (e.g., A/N feedback transmitted on separate PUCCH resources) may be applicable to various backhaul scenarios. A separate feedback mode (e.g., (ackNackFeedbackMode=separate) may be configured for a cell group or a group of downlink CCs with HARQ-ACK feedback transmissions on the same PUCCH cell.

HARQ-Ack reporting procedures may be performed separately for different CORESET pool index values. PUCCH resources that include HARQ-ACK feedback associated with different CORESET pool index values may be transmitted in the same slot using TDM. PUCCH resources carrying CSI or scheduling requests may, in some cases, not be associated with a CORESET pool index value. Hence, the network entities 105 may ensure that the UE 115-a is configured with UCI multiplexing rules that prevent such PUCCH resources from overlapping in time. If the UE 115-a is not provided with a CORESET pool index (coresetPoolIndex) or is provided with a CORESET pool index with a value of 0 for first CORESETs (e.g., CORESET 1 and CORESET 2) in an active downlink BWP of a serving cell, and if the UE 115-a is provided with a CORESET pool index with a value of 1 for second CORESETs (e.g., CORESET 3 and CORESET 4) in the active downlink BWP of the serving cell, and if the UE 115-a is provided with a separate A/N feedback mode (ackNackFeedbackMode separate), the UE 115-a may not expect a PUCCH or a physical uplink shared channel (PUSCH) transmission triggered by detection of a DCI format in a PDCCH received in a CORESET from the first CORESETs to overlap in time with a PUCCH or a PUSCH transmission triggered by detection of a DCI format in a PDCCH received in a CORESET from the second CORESETs.

In the example of FIG. 2, the UE 115-a may receive control signaling 205-a from the network entity 105-a or control signaling 205-b from the network entity 105-b. The control signaling 205 may include RRC signaling, a MAC control element (CE), or DCI, among other examples. The control signaling 205 may include an indication that separate A/N feedback (ackNackFeedbackMode separate) is enabled for the UE 115-a, an indication of multiple CORESET pool index values configured for the UE 115-a, a set of RRC parameters (e.g., simultaneousHARQ-ACK-CSI) that define rules for multiplexing A/N feedback with CSI, or any combination thereof. The control signaling 205 may also indicate an association between PUCCH resources 220 and CORESET pool index values, unified transmission configuration indicator (TCI) states, or closed loop indices.

Accordingly, the UE 115-a may transmit first UCI to the network entity 105-a on PUCCH resources 220-a within a slot and second UCI to the network entity 105-b on PUCCH resources 220-b within the slot. In some examples, the PUCCH resources 220-a and the PUCCH resources 220-b may correspond to a single CC. The first UCI may include first HARQ-ACK feedback associated with a downlink transmission from the network entity 105-a (on PDSCH resources 215-a), while the second UCI may include second HARQ-ACK feedback associated with a downlink transmission from the network entity 105-b (on PDSCH resources 215-b). The first HARQ-ACK feedback may be associated with a first CORESET pool index value (0), whereas the second HARQ-ACK feedback may be associated with a second CORESET pool index value (1). The UE 115-a may, in some examples, multiplex one or both of the first HARQ-ACK feedback or the second HARQ-ACK feedback with other UCI (e.g., scheduling requests, CSI) according to a set of UCI multiplexing rules.

Aspects of the wireless communications system 200 may be implemented to realize one or more of the following advantages. The techniques described with reference to FIG. 2 may enable the UE 115-a to perform simultaneous PUCCH transmissions in accordance with a set of UCI multiplexing rules. For example, if the UE 115-a is scheduled to transmit first HARQ-ACK feedback (associated with a first CORESET pool index) and second HARQ-ACK feedback (associated with a second CORESET pool index) on different PUCCH resources within a slot, the UE 115-a may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE 115-a may attain higher throughput (by performing simultaneous PUCCH transmissions), reduced latency (by dropping fewer PUCCH transmissions), and greater spectral efficiency (by multiplexing the HARQ-ACK feedback with other UCI).

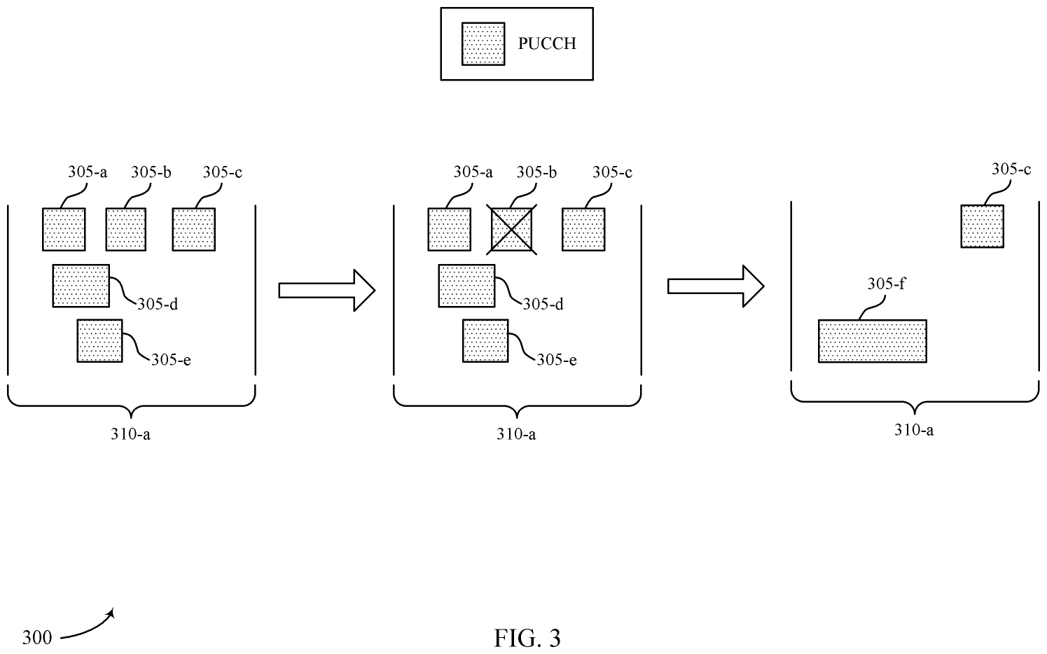

FIG. 3 illustrates an example of a resource diagram 300 that supports multiplexing techniques for simultaneous uplink control channel transmissions on a single CC in accordance with one or more aspects of the present disclosure. The resource diagram 300 may implement or be implemented by aspects of wireless communications system 100 or the wireless communications system 200. For example, the resource diagram 300 may be implemented by a UE or a network entity, which may be examples of corresponding devices described with reference to FIGS. 1 and 2. The resource diagram 300 includes a PUCCH resource 305-a, a PUCCH resource 305-b, a PUCCH resource 305-c, a PUCCH resource 305-d, and a PUCCH resource 305-e. As described herein, a UE may use a set of UCI multiplexing rules to determine whether to multiplex or drop PUCCH resources 305 that overlap in time. These UCI multiplexing rules may depend on an A/N feedback mode of the UE, a capability of the UE to support simultaneous PUCCH transmissions, an RRC configuration of the UE, or a combination thereof.

In some wireless communications systems that support NR, multiplexing rules are defined to resolve collisions between different uplink channels. For example, these multiplexing rules may resolve collisions between PUCCH resources used for HARQ-ACK and PUCCH resources used for scheduling requests, collisions between PUCCH resources used for HARQ-ACK feedback and PUCCH resources used for CSI, and collisions between PUCCH resources used for scheduling requests and PUCCH resources used for CSI, among other examples. In such cases (if specific timeline constraints are satisfied), multiple instances of UCI may be multiplexed on PUSCH or PUCCH resources. When one of the colliding channels is a PUSCH, the UCI may be multiplexed on the PUSCH.

A beta offset (which may configured via an RRC parameter or signaled in an uplink grant with DCI format 0_1) can be used to control rate matching behavior of the UE (e.g., how the UE multiplexes PUCCH and PUSCH resources, the number of PUSCH resources that a UCI payload can occupy). When multiple PUCCH transmissions collide (e.g., CSI colliding with CSI, HARQ-ACK colliding with CSI, HARQ-ACK colliding with a scheduling request, HARQ-ACK colliding with CSI and a scheduling request), the UE may perform CSI multiplexing on PUCCH first, followed by HARQ-ACK, scheduling request, or CSI multiplexing on PUCCH, and then UCI multiplexing with PUSCH.

As described herein, the first step of UCI multiplexing operations at the UE is CSI multiplexing (e.g., if there are multiple PUCCH resources carrying different CSI reports). If the UE is not configured with a first parameter
(multi-CSI-PUCCH-ResourceList) or if PUCCH resources associated with the different CSI reports are non-overlapping in time, the UE may select up to two CSI reports for transmission on non-overlapping PUCCH resources within a slot. This selection may be based on priority rules (which may depend on factors such as a type of the CSI report). If, however, the UE is configured with the first parameter
(multi-CSI-PUCCH-ResourceList), and some of the multiple PUCCH resources overlap in time, the UE may be configured to multiplex all CSI reports on one of the resources provided by the first parameter (multi-CSI-PUCCH-ResourceList). The resources specified by the first parameter (up to 2 PUCCH resources) may be different than the initial PUCCH resources selected for transmission of the CSI reports.

The PUCCH resources to be used for the resultant UCI (e.g., two or more multiplexed CSI reports) can be selected from the list of resources specified by the first parameter according to a payload size of the resultant UCI (e.g., after multiplexing the CSI reports together). The configuration of the first parameter
(multi-CSI-PUCCH-ResourceList) may be defined using fields such as SEQUENCE (SIZE (1 . . . 2)) and OFPUCCH-Resourceld. The UE may then multiplex the resulting CSI reports from the first multiplexing step with HARQ-ACK or scheduling requests (if these overlap with the selected PUCCH resources). The UE may be configured to multiplex overlapping CSI and HARQ-ACK together when a second parameter
(simultaneousHARQ-ACK-CS) is enabled for the UE. Otherwise, the UE may drop the overlapping PUCCH resources that include CSI. If the UCIs resulting from these multiplexing operations overlap with PUSCH, the UE may multiplex these UCIs with the PUSCH.

In the example of FIG. 3, the UE may be scheduled to transmit a first CSI report on the PUCCH resource 305-a, a second CSI report on the PUCCH resource 305-b, a third CSI report on the PUCCH resource 305-c, HARQ-ACK feedback on the PUCCH resource 305-d, and a scheduling request on the PUCCH resource 305-e. If, for example, the UE is unable to transmit more than two CSI reports within a slot 310-a, the UE may drop the CSI report with the lowest relative priority. For example, the UE may drop the PUCCH resource 305-b (carrying the second CSI report) if a priority of the second CSI report is lower than a priority of the first CSI report and a priority of the third CSI report. After dropping the PUCCH resource 305-b, the UE may multiplex the first CSI report with the HARQ-ACK feedback and the scheduling requests (because the PUCCH resource 305-a overlaps in time with the PUCCH resource 305-d and the PUCCH resource 305-e). The UE may transmit the resultant UCI on a PUCCH resource 305-f (e.g., a different PUCCH resource), which may be selected based on a payload size of the resultant UCI.

Aspects of the resource diagram 300 may be implemented to realize one or more of the following advantages. The techniques described with reference to FIG. 3 may enable a UE to perform simultaneous PUCCH transmissions in accordance with a set of UCI multiplexing rules. For example, if the UE is scheduled to transmit first HARQ-ACK feedback (associated with a first CORESET pool index) and second HARQ-ACK feedback (associated with a second CORESET pool index) on different PUCCH resources within a slot, the UE may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time, at least partially. As a result, the UE may attain higher throughput (by performing simultaneous PUCCH transmissions), reduced latency (by dropping fewer PUCCH transmissions), and greater spectral efficiency (by multiplexing the HARQ-ACK feedback with other UCI).

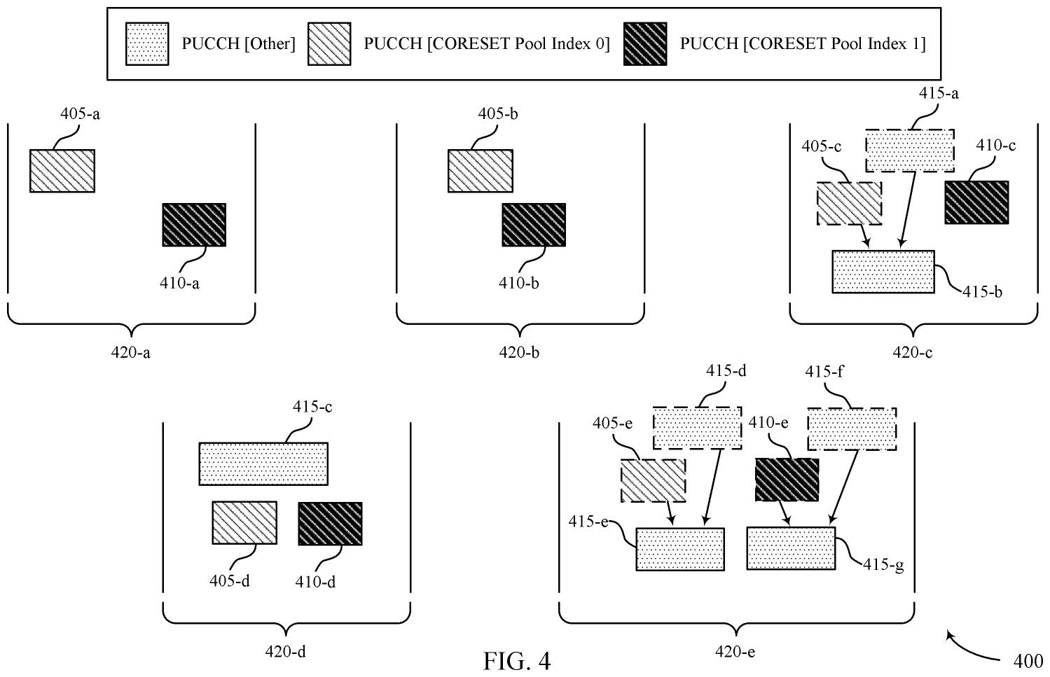

FIG. 4 illustrates an example of a resource diagram 400 that supports multiplexing techniques for simultaneous uplink control channel transmissions on a single CC in accordance with one or more aspects of the present disclosure. The resource diagram 400 may implement or be implemented by aspects of wireless communications system 100 or the wireless communications system 200. For example, the resource diagram 400 may be implemented by a UE or a network entity, which may be examples of corresponding devices described with reference to FIGS. 1 and 2. The resource diagram 400 may include PUCCH resources 405, PUCCH resources 410, and PUCCH resources 415. The PUCCH resources 405 may be associated with a first CORESET pool index, while the PUCCH resources 410 may be associated with a second CORESET pool index. Some of the PUCCH resources illustrated in the resource diagram 400 may overlap in time, at least partially, with other PUCCH resources.

In some examples, a UE may be scheduled to transmit first HARQ-ACK feedback (associated with a first CORESET pool index) on a PUCCH resource 405-a within a slot 420-a. The UE may also be scheduled to transmit second HARQ-ACK feedback (associated with a second CORESET pool index) on a PUCCH resource 410-a within the slot 420-a. If the PUCCH resource 405-a and the PUCCH resource 410-a are non-overlapping in time, the UE may successfully transmit both the first HARQ-ACK feedback and the second HARQ-ACK feedback within the slot 420-a. In other examples, if the UE is scheduled to transmit first HARQ-ACK feedback (associated with a first CORESET pool index) and second HARQ-ACK feedback (associated with a second CORESET pool index) on PUCCH resources within a slot 420-b, an error may occur if the PUCCH resources overlap in time. For example, an error may occur if a PUCCH resource 405-b (selected for transmission of the first HARQ-ACK feedback) overlaps in time with a PUCCH resource 410-b (selected for transmission of the second HARQ-ACK feedback).

In other examples, the UE may be scheduled to transmit first HARQ-ACK feedback (associated with a first CORESET pool index), second HARQ-ACK feedback (associated with a second CORESET pool index), and a CSI report on different PUCCH resources within a slot 420-c. For example, the UE may be configured to transmit the CSI report on a PUCCH resource 415-a, the first HARQ-ACK feedback on a PUCCH resource 405-c, and the second HARQ-ACK feedback on a PUCCH resource 410-c. If the PUCCH resource 405-c overlaps in time with the PUCCH resource 415-a and the CSI report is not associated with a specific CORESET pool index, the UE may multiplex the CSI report with the first HARQ-ACK feedback, and may select a PUCCH resource 415-b for transmission of the resultant (e.g., multiplexed) UCI. The UE may successfully transmit the resultant UCI (e.g., the CSI report multiplexed with the first HARQ-ACK feedback) as long as the PUCCH resource 415-b and the PUCCH resource 410-c are non-overlapping in time.

Additionally, or alternatively, the UE may be configured to transmit a CSI report, first HARQ-ACK feedback (associated with a first CORESET pool index value), and second HARQ-ACK feedback (associated with a second CORESET pool index value) on PUCCH resources within a slot 420-d. For example, the UE may be scheduled to transmit the CSI report on a PUCCH resource 415-c, the first HARQ-ACK feedback on a PUCCH resource 405-d, and the second HARQ-ACK feedback on a PUCCH resource 410-d. In some cases, the UE may attempt to multiplex the CSI report with the first HARQ-ACK feedback and the second HARQ-ACK feedback in response to determining that the PUCCH resource 415-c overlaps in time with both the PUCCH resource 405-d and the PUCCH resource 410-d and that a duration of the PUCCH resource 415-c begins prior to a duration of the PUCCH resource 405-d and a duration of the PUCCH resource 410-d. In such cases, an error may occur because the UE is attempting to multiplex HARQ-ACK feedback with different CORESET pool index values on the same PUCCH resource.

In other examples, the UE may be scheduled to transmit a first CSI report, a second CSI report, first HARQ-ACK feedback (associated with a first CORESET pool index value), and second HARQ-ACK feedback (associated with a second CORESET pool index value) on different PUCCH resources within a slot 420-e. For example, the UE may be scheduled to transmit the first CSI report on a PUCCH resource 415-d, the second CSI report on a PUCCH resource 415-f, the first HARQ-ACK feedback on a PUCCH resource 405-e, and the second HARQ-ACK feedback on a PUCCH resource 410-e. If, for example, the PUCCH resource 415-d overlaps in time with the PUCCH resource 405-e, the UE may multiplex the first CSI report with the first HARQ-ACK feedback, and may select a PUCCH resource 415-e for transmission of the resultant UCI. Similarly, if the PUCCH resource 415-f overlaps in time with the PUCCH resource 410-e, the UE may multiplex the second CSI report with the second HARQ-ACK feedback, and may select a PUCCH resource 415-g for transmission of the resultant UCI. The UE may successfully transmit both instances of multiplexed UCI within the slot 420-e provided that the PUCCH resource 415-e and the PUCCH resource 415-g (e.g., the resources selected for the multiplexed UCI transmissions) are non-overlapping in time.

Aspects of the resource diagram 400 may be implemented to realize one or more of the following advantages. The techniques described with reference to FIG. 4 may enable a UE to perform simultaneous PUCCH transmissions in accordance with a set of UCI multiplexing rules. For example, if the UE is scheduled to transmit first HARQ-ACK feedback (associated with a first CORESET pool index) and second HARQ-ACK feedback (associated with a second CORESET pool index) on different PUCCH resources within a slot, the UE may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE may attain higher throughput (by performing simultaneous PUCCH transmissions), reduced latency (by dropping fewer PUCCH transmissions), and greater spectral efficiency (by multiplexing the HARQ-ACK feedback with other UCI).

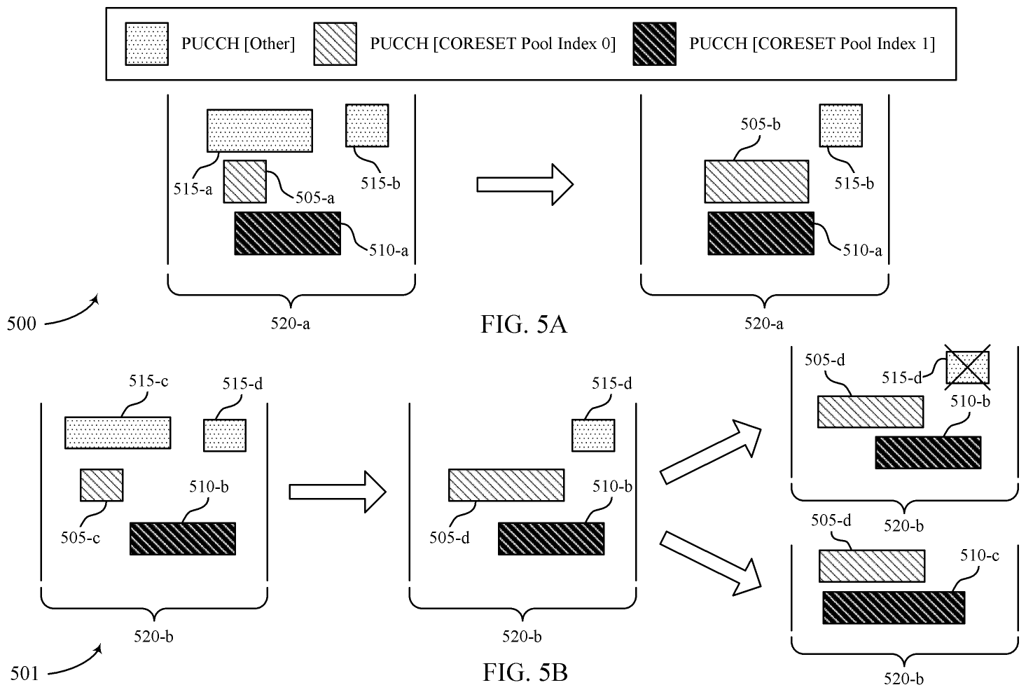

FIGS. 5A and 5B illustrate examples of a resource diagram 500 and a resource diagram 501 that support multiplexing techniques for simultaneous uplink control channel transmissions on a single CC in accordance with one or more aspects of the present disclosure. The resource diagram 500 and the resource diagram 501 may implement or be implemented by aspects of the wireless communications system 100 or the wireless communications system 200. For example, the resource diagram 500 and the resource diagram 501 may be implemented by a UE or a network entity, which may be examples of corresponding devices described with reference to FIGS. 1 and 2. The resource diagram 500 may include PUCCH resources 505, PUCCH resources 510, PUCCH resources 515, and slots 520. The PUCCH resources 505 may be associated with a first CORESET pool index value (0), while the PUCCH resources 510 may be associated with a second CORESET pool index value (1). The resource diagram 500 may illustrate UCI multiplexing techniques that support simultaneous PUCCH transmissions.

Some PUCCH resources used for transmission of CSI or scheduling requests may not be explicitly associated with a CORESET pool index value (coresetPoolIndex). However, simultaneous PUCCH transmissions may still be possible when both overlapping PUCCH resources carry HARQ-ACK feedback associated with different CORESET pool index values. If two CORESET pool index values are configured for a UE and a separate feedback reporting mode (ackNackFeedbackMode=separate) is configured for the UE and the UE is capable and configured to perform simultaneous PUCCH transmissions and a slot includes two PUCCH resources carrying HARQ-ACK feedback associated with two different CORESET pool index values, the UE may exclude a PUCCH resource carrying HARQ-ACK feedback associated with a fixed CORESET pool index value (e.g., 1), a PUCCH resource associated with an earlier start time, or a PUCCH resource with a later start time, and may apply UCI multiplexing rules to all remaining PUCCH resources. That is, the UE may apply UCI multiplexing rules to PUCCH resources carrying CSI or scheduling requests as well as PUCCH resources carrying HARQ-ACK feedback associated with the other CORESET pool index value (e.g., 0). This multiplexing operation may result in one or more PUCCH resources that are non-overlapping in time, where one of the non-overlapping PUCCH resources carries HARQ-ACK feedback associated with the other CORESET pool index value (possibly multiplexed with other UCI).

If the excluded PUCCH resource (carrying HARQ-ACK feedback associated with CORESET pool index value 1) does not overlap with any of the PUCCH resources that result from the multiplexing procedure, the UE may transmit all of the PUCCH resources from the multiplexing process along with the excluded PUCCH resource. Alternatively, if the excluded PUCCH resource overlaps with one of the non-overlapping PUCCH resources carrying HARQ-ACK feedback associated with CORESET pool index value 0, the UE may transmit all PUCCH resources that result from the multiplexing operation along with the excluded PUCCH resource. That is, the UE may transmit two instances of HARQ-ACK feedback (each associated with a respective CORESET pool index) on PUCCH resources that overlap (at least partially) in time.

In other examples, if the excluded PUCCH resource overlaps with a PUCCH resource from the one or more non-overlapping PUCCH resources that includes CSI or scheduling requests (e.g., UCI other than HARQ-ACK feedback associated with CORESET pool index value 0), the UE may drop (e.g., refrain from transmitting) the PUCCH resource, and may transmit the excluded PUCCH resource along with the one or more non-overlapping PUCCH resources (that result from the multiplexing operation) carrying HARQ-ACK feedback associated with CORESET pool index 0 (and possibly other UCI). The excluded PUCCH resource may, in some examples, overlap in time with the PUCCH resource (from the one or more non-overlapping PUCCH resources) that includes HARQ-ACK feedback associated with CORESET pool index 0 (and possibly other UCI). The UE may also transmit other UCI on PUCCH resources (from the one or more non-overlapping PUCCH resources) that do not overlap with the excluded PUCCH resource.

Alternatively, the UE may multiplex the CSI or scheduling requests (from the overlapping PUCCH resource) with the HARQ-ACK feedback associated with the excluded PUCCH resource. In some examples, the UE may select a different PUCCH resource (e.g., different from the excluded PUCCH resource) for transmission of the resultant UCI. Accordingly, the UE may transmit the resultant UCI (which includes HARQ-ACK feedback associated with CORESET pool index 1 multiplexed with other UCI) and the HARQ-ACK feedback associated with CORESET pool index 0 (possibly multiplexed with other UCI). The PUCCH resources used for transmission of the resultant UCI may, in some examples, overlap with the one or more non-overlapping PUCCH resources that result from the initial multiplexing operation. The UE may also transmit other UCI on PUCCH resources (from the one or more non-overlapping PUCCH resources) that do not overlap with the PUCCH resource selected for transmission of the resultant UCI. If different multiplexing behaviors are supported, the UE may receive an indication of one or more RRC parameters (such as simultaneousHARQ-ACK-CSI or a similar parameter) associated with a specific CORESET pool index value. These parameters may separately control whether the UE multiplexes CSI with HARQ-ACK feedback for different TRPs.

In the example of FIG. 5A, the UE may be scheduled to transmit a first CSI report, a second CSI report, first HARQ-ACK feedback (associated with CORESET pool index 0), and second HARQ-ACK feedback (associated with CORESET pool index 1) on different PUCCH resources within a slot 520-a. More specifically, the UE may be configured to transmit the first CSI report on a PUCCH resource 515-a, the second CSI report on a PUCCH resource 515-b, the first HARQ-ACK feedback on a PUCCH resource 505-a, and the second HARQ-ACK feedback on a PUCCH resource 510-a. In some examples, the UE may exclude the PUCCH resource 510-a (that includes the second HARQ-ACK feedback), and may perform UCI multiplexing for all other PUCCH resources in the slot 520-a (e.g., the PUCCH resource 515-a, the PUCCH resource 505-a, and the PUCCH resource 515-b).

Upon determining that the PUCCH resource 515-a overlaps in time (at least partially) with the PUCCH resource 505-a, the UE may multiplex the first CSI report with the first HARQ-ACK feedback in accordance with a set of UCI multiplexing rules. This multiplexing operation may result in two non-overlapping PUCCH resources (e.g., the PUCCH resource 505-b and the PUCCH resource 515-b). If the PUCCH resource 515-b does not overlap in time with the excluded PUCCH resource (e.g., the PUCCH resource 510-a), the UE may transmit the second CSI report on the PUCCH resource 515-b. If the UE is configured and capable of performing simultaneous PUCCH transmissions, the UE may transmit the resultant UCI (e.g., the first CSI report multiplexed with the first HARQ-ACK feedback) on the PUCCH resource 505-b and the second HARQ-ACK feedback on the PUCCH resource 510-a, even if the PUCCH resource 505-b overlaps in time with the PUCCH resource 510-a.

In the example of FIG. 5B, the UE may be scheduled to transmit a first CSI report, a second CSI report, first HARQ-ACK feedback (associated with CORESET pool index 0), and second HARQ-ACK feedback (associated with CORESET pool index 1) on different PUCCH resources within a slot 520-b. More specifically, the UE may be configured to transmit the first CSI report on a PUCCH resource 515-c, the second CSI report on a PUCCH resource 515-d, the first HARQ-ACK feedback on a PUCCH resource 505-c, and the second HARQ-ACK feedback on a PUCCH resource 510-b. In some examples, the UE may exclude the PUCCH resource 510-b (that includes the second HARQ-ACK feedback), and may perform UCI multiplexing for all other PUCCH resources in the slot 520-b (e.g., the PUCCH resource 505-c, the PUCCH resource 515-c, and the PUCCH resource 515-d). Upon determining that the PUCCH resource 515-c overlaps in time with the PUCCH resource 505-c, the UE may multiplex the first CSI report with the first HARQ-ACK feedback in accordance with a set of UCI multiplexing rules. This multiplexing operation may result in two non-overlapping PUCCH resources (e.g., the PUCCH resource 505-d and the PUCCH resource 515-d).

In some examples, if the UE determines that that the excluded PUCCH resource (e.g., the PUCCH resource 510-b) overlaps in time with the PUCCH resource 515-d, the UE may drop the PUCCH resource 515-d (and refrain from transmitting the second CSI report). If the UE is configured and capable of performing simultaneous PUCCH transmissions, the UE may transmit the resultant UCI (e.g., the first CSI report multiplexed with the first HARQ-ACK feedback) on the PUCCH resource 505-d, and may transmit the second HARQ-ACK feedback on the PUCCH resource 510-b, even if the PUCCH resource 505-d overlaps in time with the PUCCH resource 510-b. Alternatively, the UE may multiplex the second CSI report with the second HARQ-ACK feedback, and may select a PUCCH resource 510-c for transmission of the multiplexed UCI. The PUCCH resource 510-c may be the same or different from the PUCCH resource 510-b that was initially selected for transmission of the second HARQ-ACK feedback. If the UE is configured and capable of performing simultaneous PUCCH transmissions, the UE may transmit the first resultant UCI (e.g., the first CSI report multiplexed with the first HARQ-ACK feedback) on the PUCCH resource 505-d, and may transmit the second resultant UCI (e.g., the second CSI report multiplexed with the second HARQ-ACK feedback) on the PUCCH resource 510-c, even if the PUCCH resource 505-d overlaps in time with the PUCCH resource 510-c.

Aspects of the resource diagram 500 and the resource diagram 501 may be implemented to realize one or more of the following advantages. The techniques described with reference to FIGS. 5A and 5B may enable a UE to perform simultaneous PUCCH transmissions in accordance with a set of UCI multiplexing rules. For example, if the UE is scheduled to transmit first HARQ-ACK feedback (associated with a first CORESET pool index) and second HARQ-ACK feedback (associated with a second CORESET pool index) on different PUCCH resources within a slot, the UE may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE may attain higher throughput (by performing simultaneous PUCCH transmissions), reduced latency (by dropping fewer PUCCH transmissions), and greater spectral efficiency (by multiplexing the HARQ-ACK feedback with other UCI).

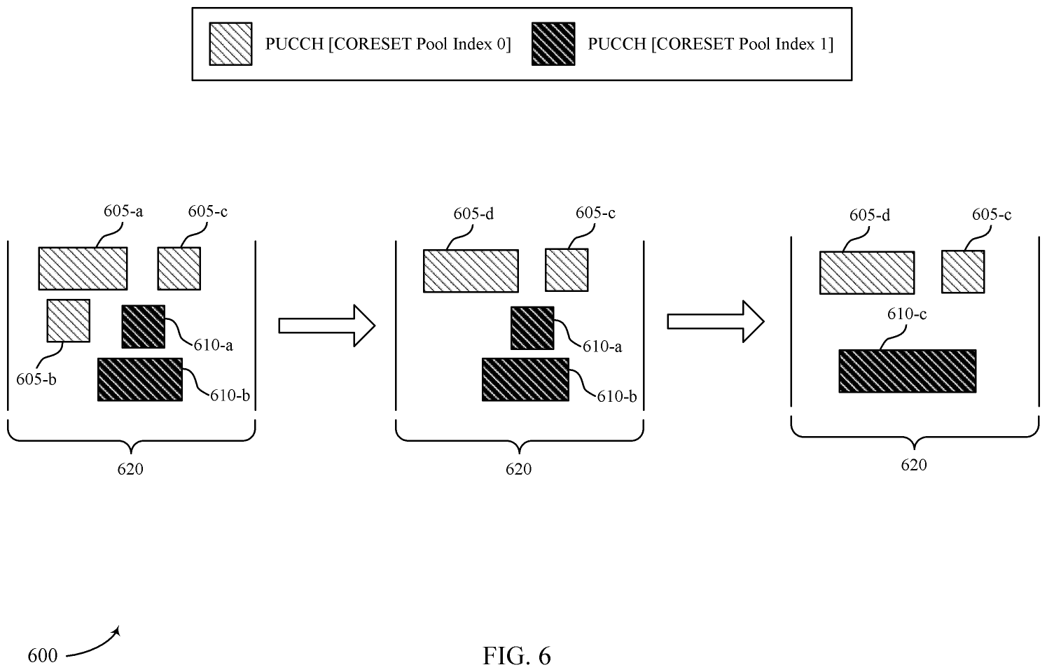

FIG. 6 illustrates an example of a resource diagram 600 that supports multiplexing techniques for simultaneous uplink control channel transmissions on a single CC in accordance with one or more aspects of the present disclosure. The resource diagram 600 may implement or be implemented by aspects of wireless communications system 100 or the wireless communications system 200. For example, the resource diagram 600 may be implemented by a UE or a network entity, which may be examples of corresponding devices described with reference to FIGS. 1 and 2. The resource diagram 600 may include PUCCH resources 605, which may be examples of PUCCH resources 505 described with reference to FIGS. 5A and 5B. Similarly, the resource diagram 600 may include PUCCH resources 610, which may be examples of PUCCH resources 510 described with reference to FIGS. 5A and 5B. In the resource diagram 600, a UE may multiplex different instances of UCI that are associated with the same CORESET pool index.

PUCCH resources carrying CSI or scheduling requests may, in some examples, be explicitly associated with a CORESET pool index value. As such, simultaneous PUCCH transmissions may be possible for HARQ-ACK feedback as well as for CSI, scheduling requests, or any combination thereof. The association between PUCCH resources and CORESET pool index values can be determined using different mechanisms. In some examples, the association may be explicitly configured per PUCCH resource. In other examples, the association may be based on a unified TCI state (e.g., a joint downlink uplink TCI or an uplink TCI) indicated for each PUCCH resource. Two unified TCI states can be signaled to the UE (via DCI or MAC-CE), where each unified TCI state is associated with a respective CORESET pool index value. This value may be applicable to one or more PUCCH resources. Additionally, or alternatively, the association may be based on a relationship between PUCCH resources and closed loop indices (0 or 1) used for PUCCH closed loop power control.

If two CORESET pool index values are configured for the UE and a separate A/N feedback reporting mode (ackNackFeedbackMode=separate) is configured for the UE and if the UE is capable and configured to perform simultaneous PUCCH transmissions, the UE may apply UCI multiplexing rules to all PUCCH resources associated with CORESET pool index value 0 (e.g., PUCCH resources carrying HARQ-ACK feedback, CSI, or scheduling requests associated with CORESET pool index value 0). This may result in a first set of one or more PUCCH resources that are non-overlapping in time. The UE may also apply UCI multiplexing rules to all PUCCH resources associated with CORESET pool index value 1 (e.g., PUCCH resources carrying HARQ-ACK feedback, CSI, or scheduling requests associated with CORESET pool index value 1). This may result in a second set of one or more PUCCH resources that are non-overlapping in time.

Accordingly, the UE may transmit first UCI (e.g., HARQ-ACK feedback, CSI, or scheduling requests associated with CORESET pool index value 0) on the first set of one or more PUCCH resources, and may transmit second UCI (e.g., HARQ-ACK feedback, CSI, or scheduling requests associated with CORESET pool index value 1) on the second set of one or more PUCCH resources, even if some PUCCH resources from the first set of one or more PUCCH resources overlap in time with the second set of one or more PUCCH resources. In some examples, separate RRC parameters may control the multiplexing behavior of the UE for different CORESET pool index values. For example, a first RRC parameter (e.g., simultaneousHARQ-ACK-CSI) may control multiplexing behavior for UCI associated with CORESET pool index value 0, while a second RRC parameter may control multiplexing behavior for UCI associated with CORESET pool index value 1.

In the example of FIG. 6, the UE may be configured to transmit a first CSI report (associated with CORESET pool index value 0), a second CSI report (associated with CORESET pool index value 0), a third CSI report (associated with CORESET pool index value 1), first HARQ-ACK feedback (associated with CORESET pool index value 0), and second HARQ-ACK feedback (associated with CORESET pool index value 1) within a slot 620. More specifically, the UE may be scheduled to transmit the first CSI report on a PUCCH resource 605-a, the second CSI report on a PUCCH resource 605-c, the third CSI report on a PUCCH resource 610-a, the first HARQ-ACK feedback on a PUCCH resource 605-b, and the second HARQ-ACK feedback on a PUCCH resource 610-b.

Upon determining that the PUCCH resource 605-a, the PUCCH resource 605-c, and the PUCCH resource 605-b are associated with the same CORESET pool index (e.g., 0), the UE may perform UCI multiplexing for the PUCCH resource 605-a, the PUCCH resource 605-c, and PUCCH resource 605-b in accordance with a set of UCI multiplexing rules. Upon determining that the PUCCH resource 605-a overlaps in time with the PUCCH resource 605-b, the UE may multiplex the first CSI report with the first HARQ-ACK feedback and select a PUCCH resource 605-d for transmission of the resultant UCI. This multiplexing operation may result in two non-overlapping PUCCH resources (e.g., the PUCCH resource 605-d and the PUCCH resource 605-c). Upon determining that the PUCCH resource 610-a and the PUCCH resource 610-b are associated with the same CORESET pool index (e.g., 1), the UE may perform UCI multiplexing for the PUCCH resource 610-a and the PUCCH resource 610-b according to a set of UCI multiplexing rules.

The UE may multiplex the third CSI report with the second HARQ-ACK feedback in response to determining that the PUCCH resource 610-a overlaps in time with the PUCCH resource 610-b. Accordingly, the UE may select a PUCCH resource 610-c for transmission of the resulting UCI. If the UE is configured and capable of performing simultaneous PUCCH transmissions, the UE may transmit the first resultant UCI (e.g., the first CSI report multiplexed with the first HARQ-ACK feedback) on the PUCCH resource 605-d, the second CSI report on PUCCH resource 605-c, and the second resultant UCI (e.g., the second CSI report multiplexed with the second HARQ-ACK feedback) on the PUCCH resource 610-c, even if one or both the PUCCH resource 605-d or the PUCCH resource 605-c overlap in time with the PUCCH resource 610-c.

Aspects of the resource diagram 600 may be implemented to realize one or more of the following advantages. The techniques described with reference to FIG. 6 may enable a UE to perform simultaneous PUCCH transmissions in accordance with a set of UCI multiplexing rules. For example, if the UE is scheduled to transmit first HARQ-ACK feedback (associated with a first CORESET pool index) and second HARQ-ACK feedback (associated with a second CORESET pool index) on different PUCCH resources within a slot, the UE may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE may attain higher throughput (by performing simultaneous PUCCH transmissions), reduced latency (by dropping fewer PUCCH transmissions), and greater spectral efficiency (by multiplexing the HARQ-ACK feedback with other UCI).

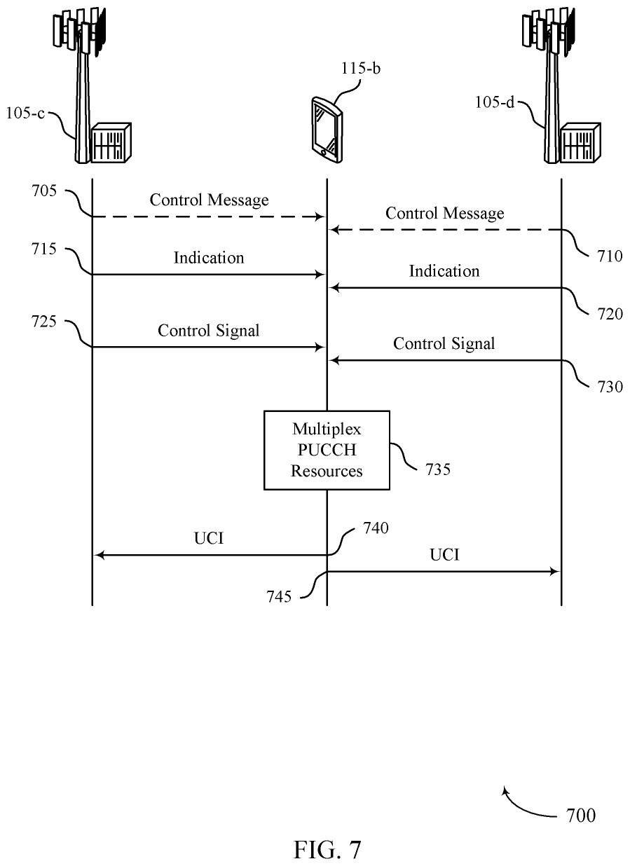

FIG. 7 illustrates an example of a process flow 700 that supports multiplexing techniques for simultaneous uplink control channel transmissions on a single CC in accordance with one or more aspects of the present disclosure. The process flow 700 may implement or be implemented by aspects of the wireless communications system 100 or the wireless communications system 200. For example, the process flow 700 may include a UE 115-b, a network entity 105-c, and a network entity 105-d, which may be examples of corresponding devices described with reference to FIGS. 1 and 2. In the following description of the process flow 700, operations between the UE 115-b and the network entities 105 may be performed in a different order or at a different time than as shown. Additionally, or alternatively, operations between the UE 115-b and the network entities 105 may be omitted from or added to the process flow 700.

The UE 115-b may, in some examples, receive a control message from the network entity 105-c (e.g., a first TRP) at 705. Additionally, or alternatively, the UE 115-b may receive a control message from the network entity 105-d (e.g., a second TRP) at 710. The control message from the network entities 105 may indicate that simultaneous PUCCH transmissions are enabled for the UE 115-b. The control messages may also indicate a first set of RRC parameters associated with a first CORESET pool index, a second set of RRC parameters associated with a second CORESET pool index, or both. The first set of RRC parameters may define rules for multiplexing CSI with HARQ-ACK feedback associated with the first CORESET pool index, while the second set of parameters may define rules for multiplexing CSI with HARQ-ACK feedback associated with the second CORESET pool index. Additionally, or alternatively, the control messages may indicate that a separate HARQ-ACK feedback mode is enabled for the UE 115-b.

At 715, the UE 115-b may receive an indication to transmit first UCI on a first PUCCH resource within a slot. At 720, the UE 115-b may receive an indication to transmit second UCI on a second PUCCH resource within the slot. The first UCI may include HARQ-ACK feedback associated with the first CORESET pool index, while the second UCI may include HARQ-ACK feedback associated with the second CORESET pool index. The HARQ-ACK feedback associated with the first CORESET pool index may correspond to a PDSCH transmission from the network entity 105-c, whereas the HARQ-ACK feedback associated with the second CORESET pool index may correspond to a PDSCH transmission from the network entity 105-d. In some examples, at least a portion of the first PUCCH resource may overlap in time with the second PUCCH resource. In other examples, the first PUCCH resource and the second PUCCH resource may be non-overlapping (e.g., discontinuous) in time.

At 725, the UE 115-b may receive a control signal (from the network entity 105-c) that schedules transmission of third UCI on a set of PUCCH resources within the slot. Alternatively, the UE 115-b may receive the control signal from the network entity 105-d at 730. The third UCI may include a scheduling request (also referred to herein as scheduling information), CSI, or both. At 735, the UE 115-b may multiplex the first PUCCH resource (associated with the first UCI) with the set of PUCCH resources (associated with the third UCI) in accordance with a set of uplink multiplexing rules. The multiplexing may result in one or more PUCCH resources within the slot. In some examples, these PUCCH resources may be non-overlapping in time. The UE 115-b may, in some examples, exclude the second PUCCH resource from the multiplexing based on the second CORESET pool index (associated with the second PUCCH) having a fixed value. Additionally, or alternatively, the UE 115-b may exclude the second PUCCH resource from the multiplexing based on a duration of the second PUCCH resource starting before (or after) a duration of the first PUCCH resource.

At 740 and 745, the UE 115-b may transmit the first UCI, the second UCI, and at least a portion of the third UCI in the slot based on the multiplexing. For example, the UE 115-b may transmit at least the first UCI on the one or more non-overlapping PUCCH resources that resulted from the multiplexing operation. In some examples, the UE 115-b may transmit one or more of the first UCI, the second UCI, or the third UCI in the slot based on determining that the second PUCCH resource and a portion of the one or more PUCCH resources that does not include the first UCI are non-overlapping in time. In other examples, if the second PUCCH resource overlaps in time with the portion of the one or more PUCCH resources that does not include the first UCI, the UE 115-b may drop a portion of the third UCI that overlaps with the second UCI. Alternatively, the UE 115-b may multiplex the overlapping portion of the third UCI with the second UCI, and may transmit the resultant UCI (e.g., the second UCI multiplexed with a portion of the third UCI) on the second PUCCH resource or on a third PUCCH resource that is different from the second PUCCH resource.

Aspects of the process flow 700 may be implemented to realize one or more of the following advantages. The techniques described with reference to FIG. 7 may enable the UE 115-b to perform simultaneous PUCCH transmissions in accordance with a set of UCI multiplexing rules. For example, if the UE 115-b is scheduled to transmit first HARQ-ACK feedback (associated with a first CORESET pool index) and second HARQ-ACK feedback (associated with a second CORESET pool index) on different PUCCH resources within a slot, the UE 115-b may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE 115-b may attain higher throughput (by performing simultaneous PUCCH transmissions), reduced latency (by dropping fewer PUCCH transmissions), and greater spectral efficiency (by multiplexing the HARQ-ACK feedback with other UCI).

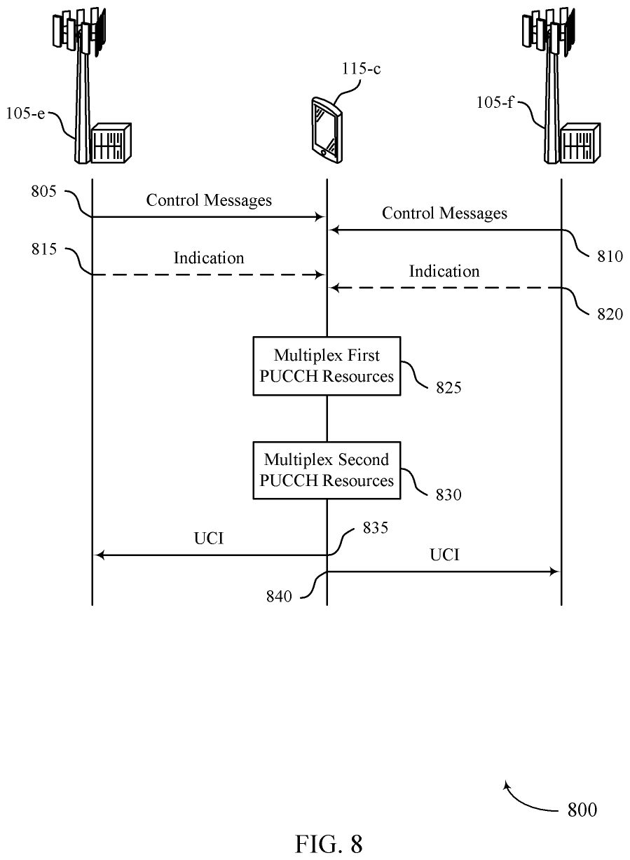

FIG. 8 illustrates an example of a process flow 800 that supports multiplexing techniques for simultaneous uplink control channel transmissions on a single CC in accordance with one or more aspects of the present disclosure. The process flow 800 may implement or be implemented by aspects of the wireless communications system 100 or the wireless communications system 200. For example, the process flow 800 may include a UE 115-c, a network entity 105-e, and a network entity 105-f, which may be examples of corresponding devices described with reference to FIGS. 1 and 2. In the following description of the process flow 800, operations between the UE 115-c and the network entities 105 may be performed in a different order or at a different time than as shown. Additionally, or alternatively, operations between the UE 115-c and the network entities 105 may be omitted from or added to the process flow 800.

At 805, the UE 115-c may receive a first set of one or more control messages that schedule transmission of first UCI on a first set of multiple PUCCH resources within a slot. The first UCI may include HARQ-ACK feedback, a scheduling request, CSI, or a combination thereof. At 810, the UE 115-c may receive a second set of one or more control message that schedule transmission of second UCI on a second set of multiple PUCCH resources within the slot. The second UCI may also include HARQ-ACK feedback, a scheduling request, CSI, or a combination thereof. The first set of multiple PUCCH resources may be associated with a first CORESET pool index, whereas the second set of multiple PUCCH resources may be associated with a second CORESET pool index (that is different from the first CORESET pool index).

At 815, the UE 115-c may receive an indication of an association between CORESET pool indices and PUCCH resources available for transmission of scheduling requests or CSI. At 820, the UE 115-c may receive an indication of an association between unified TCI states and PUCCH resources available for transmission of scheduling requests or CSI. Additionally, or alternatively, the UE 115-c may receive (from one or both of the network entity 105-e or the network entity 105-f) an indication of an association between closed loop indices and PUCCH resources available for transmission of scheduling requests or CSI. The UE 115-c may also receive a control signal that indicates two or more CORESET pool indices configured for the UE 115-c. In some examples, the network entity 105-e or the network entity 105-f may transmit an indication that a separate HARQ-ACK feedback mode is enabled for the UE 115-c, an indication that simultaneous PUCCH transmissions are enabled for the UE 115-c, or both.

At 825, the UE 115-c may multiplex the first set of multiple PUCCH resources in accordance with a set of uplink multiplexing rules. Multiplexing the first set of multiple PUCCH resources may result in a first set of one or more PUCCH resources that are non-overlapping in time. At 830, the UE 115-c may multiplex the second set of multiple PUCCH resources in accordance with the set of uplink multiplexing rules. Multiplexing the second set of multiple PUCCH resources may result in a second set of one or more PUCCH resources that are non-overlapping in time. In some examples, the UE 115-c may multiplex the first set of multiple PUCCH resources based on an association between the first set of multiple PUCCH resources and the first CORESET pool index. In other examples, the UE 115-c may multiplex the first set of multiple PUCCH resources based on an association between the first set of multiple PUCCH resources and a TCI state or a closed loop index corresponding to the first CORESET pool index. Likewise, the UE 115-c may multiplex the second set of multiple PUCCH resources based on an association between the second set of multiple PUCCH resources and one or more of the second CORESET pool index, a TCI state corresponding to the second CORESET pool index, or a closed loop index corresponding to the second CORESET pool index.

At 835, the UE 115-c may transmit at least a portion of the first UCI on the first set of one or more PUCCH resources. At 840, the UE 115-c may transmit at least a portion of the second UCI on the second set of one or more PUCCH resources. In some examples, the first set of one or more PUCCH resources and the second set of one or more PUCCH resources may be non-overlapping in time. In other examples, the first set of one or more PUCCH resources may overlap in time (at least partially) with the second set of one or more PUCCH resources. The UE 115-c may transmit the first UCI and the second UCI on overlapping PUCCH resources based on a capability of the UE 115-c to support simultaneous PUCCH transmissions. In some examples, the UE 115-c may drop at least one PUCCH resource from the first set of one or more PUCCH resources based on determining that the at least one PUCCH resource overlaps in time with the second set of one or more PUCCH resources.

Aspects of the process flow 800 may be implemented to realize one or more of the following advantages. The techniques described with reference to FIG. 8 may enable the UE 115-c to perform simultaneous PUCCH transmissions in accordance with a set of UCI multiplexing rules. For example, if the UE 115-c is scheduled to transmit first HARQ-ACK feedback (associated with a first CORESET pool index) and second HARQ-ACK feedback (associated with a second CORESET pool index) on different PUCCH resources within a slot, the UE 115-c may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the UE 115-c may attain higher throughput (by performing simultaneous PUCCH transmissions), reduced latency (by dropping fewer PUCCH transmissions), and greater spectral efficiency (by multiplexing the HARQ-ACK feedback with other UCI).

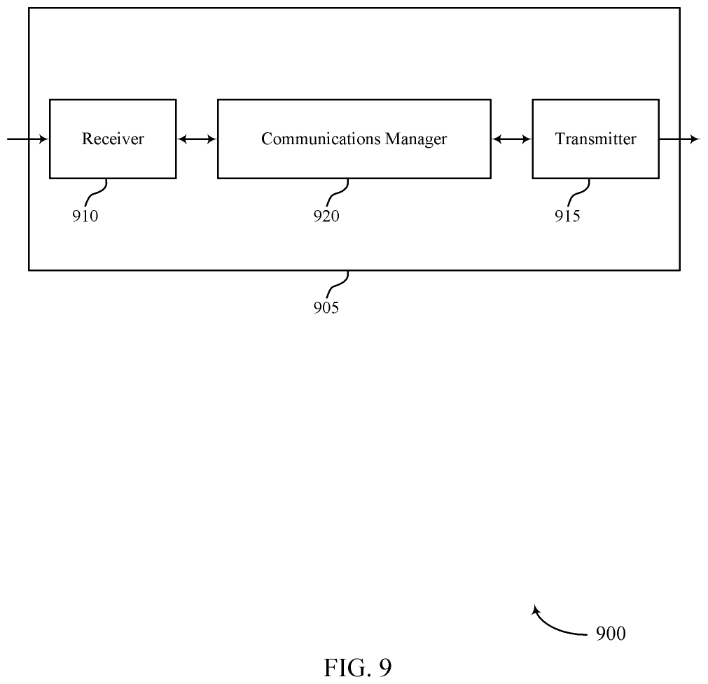

FIG. 9 shows a block diagram 900 of a device 905 that supports multiplexing techniques for simultaneous uplink control channel transmissions on a single CC in accordance with one or more aspects of the present disclosure. The device 905 may be an example of aspects of a UE 115, as described herein with reference to FIGS. 1 through 8. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to multiplexing techniques for simultaneous uplink control channel transmissions on a single CC). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to multiplexing techniques for simultaneous uplink control channel transmissions on a single CC). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of multiplexing techniques for simultaneous uplink control channel transmissions on a single CC, as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory). For example, one or more instructions stored in the memory may be executable by the processor to cause the apparatus to, based at least in part on the one or more instructions, perform one or more of the functions described herein.

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations, as described herein.

The communications manager 920 may support wireless communication at the device 905 in accordance with examples disclosed herein. For example, the communications manager 920 may be configured as or otherwise support a means for receiving an indication to transmit first UCI on a first uplink control channel resource within a slot and second UCI on a second uplink control channel resource within the slot, where the first UCI includes HARQ-ACK information (also referred to herein as HARQ-ACK feedback) associated with a first CORESET pool index and the second UCI includes HARQ-ACK information associated with a second CORESET pool index. The communications manager 920 may be configured as or otherwise support a means for receiving a control signal that schedules transmission of third UCI on a first one or more uplink control channel resources within the slot, where the third UCI includes scheduling information or CSI. The communications manager 920 may be configured as or otherwise support a means for multiplexing the first uplink control channel resource with the first one or more uplink control channel resources in accordance with one or more uplink multiplexing rules, where the multiplexing results in a second one or more uplink control channel resources within the slot. The communications manager 920 may be configured as or otherwise support a means for transmitting the first UCI, the second UCI, and at least a portion of the third UCI in the slot based on the multiplexing.

Additionally, or alternatively, the communications manager 920 may support wireless communication at the device 905 in accordance with examples disclosed herein. For example, the communications manager 920 may be configured as or otherwise support a means for receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index. The communications manager 920 may be configured as or otherwise support a means for receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index.

The communications manager 920 may be configured as or otherwise support a means for multiplexing the first set of multiple uplink control channel resources in accordance with one or more uplink multiplexing rules, where multiplexing the first set of multiple uplink control channel resources results in a first one or more uplink control channel resources. The communications manager 920 may be configured as or otherwise support a means for multiplexing the second set of multiple uplink control channel resources in accordance with the one or more uplink multiplexing rules, where multiplexing the second set of multiple uplink control channel resources results in a second one or more uplink control channel resources. The communications manager 920 may be configured as or otherwise support a means for transmitting at least a portion of the first UCI on the first one or more uplink control channel resources and at least a portion of the second UCI on the second one or more uplink control channel resources.

By including or configuring the communications manager 920 in accordance with examples, as described herein, the device 905 (e.g., a processor controlling or otherwise coupled with the receiver 910, the transmitter 915, the communications manager 920, or a combination thereof) may support techniques for more efficient utilization of communication resources by enabling the device 905 to perform simultaneous PUCCH transmissions in accordance with a set of UCI multiplexing rules.

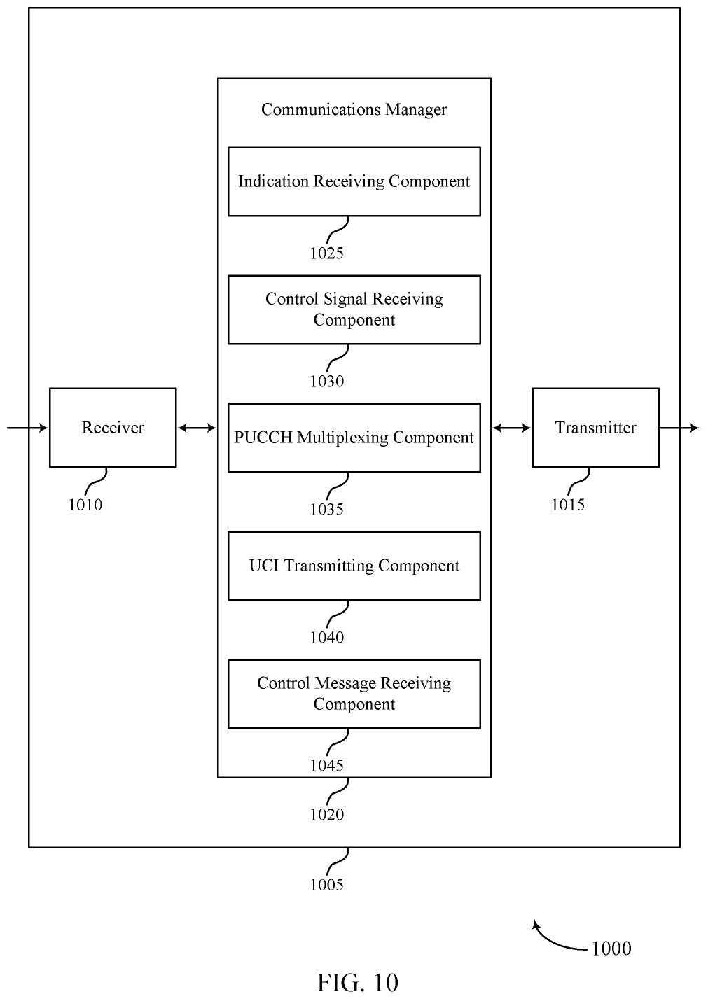

FIG. 10 shows a block diagram 1000 of a device 1005 that supports multiplexing techniques for simultaneous uplink control channel transmissions on a single CC in accordance with one or more aspects of the present disclosure. The device 1005 may be an example of aspects of a device 905 or a UE 115, as described herein with reference to FIGS. 1 through 9. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to multiplexing techniques for simultaneous uplink control channel transmissions on a single CC). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to multiplexing techniques for simultaneous uplink control channel transmissions on a single CC). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of multiplexing techniques for simultaneous uplink control channel transmissions on a single CC, as described herein. For example, the communications manager 1020 may include an indication receiving component 1025, a control signal receiving component 1030, a PUCCH multiplexing component 1035, a UCI transmitting component 1040, a control message receiving component 1045, or any combination thereof. The communications manager 1020 may be an example of aspects of a communications manager 920, as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations, as described herein.

The communications manager 1020 may support wireless communication at the device 1005 in accordance with examples disclosed herein. The indication receiving component 1025 may be configured as or otherwise support a means for receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index. The control signal receiving component 1030 may be configured as or otherwise support a means for receiving a control signal that schedules transmission of third UCI on a first one or more uplink control channel resources within the slot, where the third UCI includes scheduling information or CSI. The PUCCH multiplexing component 1035 may be configured as or otherwise support a means for multiplexing the first uplink control channel resource with the first one or more uplink control channel resources in accordance with one or more uplink multiplexing rules, where the multiplexing results in a second one or more uplink control channel resources within the slot. The UCI transmitting component 1040 may be configured as or otherwise support a means for transmitting the first UCI, the second UCI, and at least a portion of the third UCI in the slot based on the multiplexing.

Additionally, or alternatively, the communications manager 1020 may support wireless communication at the device 1005 in accordance with examples disclosed herein. The control message receiving component 1045 may be configured as or otherwise support a means for receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index. The control message receiving component 1045 may be configured as or otherwise support a means for receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index.

The PUCCH multiplexing component 1035 may be configured as or otherwise support a means for multiplexing the first set of multiple uplink control channel resources in accordance with one or more uplink multiplexing rules, where multiplexing the first set of multiple uplink control channel resources results in a first one or more uplink control channel resources. The PUCCH multiplexing component 1035 may be configured as or otherwise support a means for multiplexing the second set of multiple uplink control channel resources in accordance with the one or more uplink multiplexing rules, where multiplexing the second set of multiple uplink control channel resources results in a second one or more uplink control channel resources. The UCI transmitting component 1040 may be configured as or otherwise support a means for transmitting at least a portion of the first UCI on the first one or more uplink control channel resources and at least a portion of the second UCI on the second one or more uplink control channel resources.

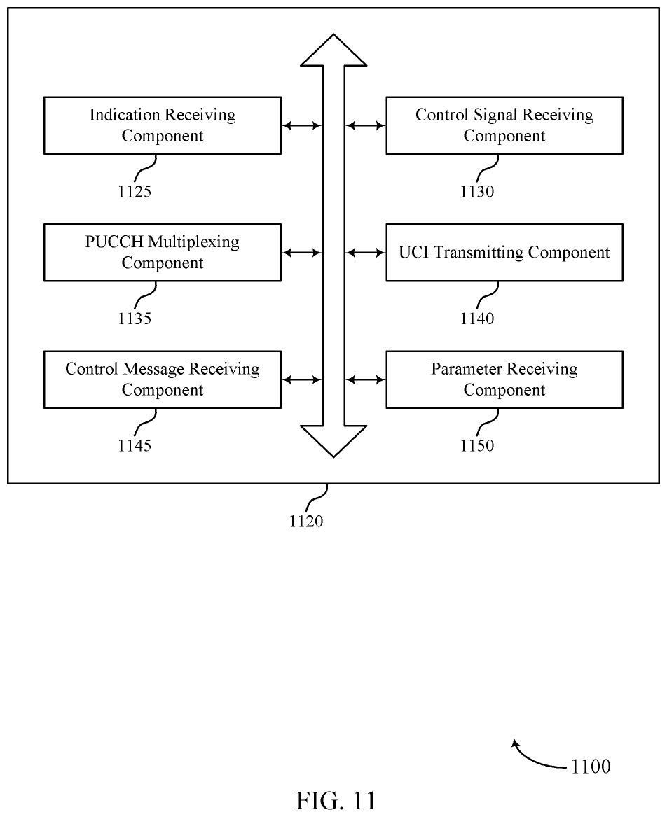

FIG. 11 shows a block diagram 1100 of a communications manager 1120 that supports multiplexing techniques for simultaneous uplink control channel transmissions on a single CC in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of multiplexing techniques for simultaneous uplink control channel transmissions on a single CC, as described herein. For example, the communications manager 1120 may include an indication receiving component 1125, a control signal receiving component 1130, a PUCCH multiplexing component 1135, a UCI transmitting component 1140, a control message receiving component 1145, a parameter receiving component 1150, or any combination thereof. Each of these components may communicate, directly or indirectly, with one another (e.g., via one or more buses).

The communications manager 1120 may support wireless communication at a UE in accordance with examples disclosed herein. The indication receiving component 1125 may be configured as or otherwise support a means for receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index. The control signal receiving component 1130 may be configured as or otherwise support a means for receiving a control signal that schedules transmission of third UCI on a first one or more uplink control channel resources within the slot, where the third UCI includes scheduling information or CSI. The PUCCH multiplexing component 1135 may be configured as or otherwise support a means for multiplexing the first uplink control channel resource with the first one or more uplink control channel resources in accordance with one or more uplink multiplexing rules, where the multiplexing results in a second one or more uplink control channel resources within the slot. The UCI transmitting component 1140 may be configured as or otherwise support a means for transmitting the first UCI, the second UCI, and at least a portion of the third UCI in the slot based on the multiplexing.

In some examples, the second uplink control channel resource is excluded from the multiplexing based on the second CORESET pool index having a fixed value. In some examples, the second uplink control channel resource is excluded from the multiplexing based on a time duration of the second uplink control channel resource starting prior to a time duration of the first uplink control channel resource. In some examples, the second uplink control channel resource is excluded from the multiplexing based on a time duration of the second uplink control channel resource starting after a time duration of the first uplink control channel resource.

In some examples, to support transmitting the first UCI, the second UCI, and at least a portion of the third UCI, the UCI transmitting component 1140 may be configured as or otherwise support a means for transmitting the second UCI on the second uplink control channel resource. In some examples, to support transmitting the first UCI, the second UCI, and at least a portion of the third UCI, the UCI transmitting component 1140 may be configured as or otherwise support a means for transmitting one or both of the first UCI or the third UCI on the second one or more uplink control channel resources based on determining that the second uplink control channel resource and the second one or more uplink control channel resources are non-overlapping in time.

In some examples, a first portion of the second one or more uplink control channel resources corresponds to the HARQ-ACK information associated with the first CORESET pool index, a first portion of the third UCI, or both. In some examples, a second portion of the second one or more uplink control channel resources corresponds to a second portion of the third UCI.

In some examples, to support transmitting the first UCI, the second UCI, and at least a portion of the third UCI, the UCI transmitting component 1140 may be configured as or otherwise support a means for transmitting the second UCI on the second uplink control channel resource. In some examples, to support transmitting the first UCI, the second UCI, and at least a portion of the third UCI, the UCI transmitting component 1140 may be configured as or otherwise support a means for transmitting one or both of the first UCI or the first portion of the third UCI on the first portion of the second one or more uplink control channel resources. In some examples, to support transmitting the first UCI, the second UCI, and at least a portion of the third UCI, the UCI transmitting component 1140 may be configured as or otherwise support a means for transmitting the second portion of the third UCI on the second portion of the second one or more uplink control channel resources based on determining that the second uplink control channel resource and the second portion of the second one or more uplink control channel resources are non-overlapping in time.

In some examples, the PUCCH multiplexing component 1135 may be configured as or otherwise support a means for dropping the second portion of the second one or more uplink control channel resources based on determining that the second uplink control channel resource and the second portion of the second one or more uplink control channel resources at least partially overlap in time.

In some examples, to support transmitting the first UCI, the second UCI, and at least a portion of the third UCI, the UCI transmitting component 1140 may be configured as or otherwise support a means for transmitting the second UCI on the second uplink control channel resource. In some examples, to support transmitting the first UCI, the second UCI, and at least a portion of the third UCI, the UCI transmitting component 1140 may be configured as or otherwise support a means for transmitting one or both of the first UCI or the first portion of the third UCI on the first portion of the second one or more uplink control channel resources. In some examples, to support transmitting the first UCI, the second UCI, and at least a portion of the third UCI, the UCI transmitting component 1140 may be configured as or otherwise support a means for refraining from transmitting the second portion of the third UCI based on dropping the second portion of the second one or more uplink control channel resources. In some examples, to support transmitting the first UCI, the second UCI, and at least a portion of the third UCI, the UCI transmitting component 1140 may be configured as or otherwise support a means for transmitting a third portion of the third UCI on a third portion of the second one or more uplink control channel resources based on determining that the second uplink control channel resource and the third portion of the second one or more uplink control channel resources are non-overlapping in time.

In some examples, the PUCCH multiplexing component 1135 may be configured as or otherwise support a means for multiplexing the second uplink control channel resource with the second portion of the second one or more uplink control channel resources based on determining that the second uplink control channel resource and the second portion of the second one or more uplink control channel resources at least partially overlap in time.

In some examples, to support transmitting the first UCI, the second UCI, and at least a portion of the third UCI, the UCI transmitting component 1140 may be configured as or otherwise support a means for transmitting the second UCI and the second portion of the third UCI on the second uplink control channel resource or a third uplink control channel resource that is different from the second uplink control channel resource based on multiplexing the second uplink control channel resource with the second portion of the second one or more uplink control channel resources. In some examples, to support transmitting the first UCI, the second UCI, and at least a portion of the third UCI, the UCI transmitting component 1140 may be configured as or otherwise support a means for transmitting one or both of the first UCI or the first portion of the third UCI on the first portion of the second one or more uplink control channel resources. In some examples, to support transmitting the first UCI, the second UCI, and at least a portion of the third UCI, the UCI transmitting component 1140 may be configured as or otherwise support a means for transmitting a third portion of the third UCI on a third portion of the second one or more uplink control channel resources based on determining that the second uplink control channel resource and the third portion of the second one or more uplink control channel resources are non-overlapping in time.

In some examples, the control message receiving component 1145 may be configured as or otherwise support a means for receiving a control message that indicates a separate HARQ-ACK feedback mode for the UE, where the second uplink control channel resource is excluded from the multiplexing based on the separate HARQ-ACK feedback mode of the UE.

In some examples, the control message receiving component 1145 may be configured as or otherwise support a means for receiving a control message that indicates simultaneous uplink control channel transmissions are enabled for the UE, where transmitting the first UCI, the second UCI, and at least a portion of the third UCI is based on the control message.

In some examples, the control message receiving component 1145 may be configured as or otherwise support a means for receiving a control message that indicates a first one or more parameters associated with the first CORESET pool index and a second one or more parameters associated with the second CORESET pool index, where multiplexing the first uplink control channel resource with the first one or more uplink control channel resources is based on the first one or more parameters.

In some examples, the first one or more parameters define rules for multiplexing CSI with HARQ-ACK information associated with the first CORESET pool index. In some examples, the second one or more parameters define rules for multiplexing CSI with HARQ-ACK information associated with the second CORESET pool index.

In some examples, transmitting the first UCI, the second UCI, and at least a portion of the third UCI is based on a capability of the UE to support simultaneous uplink control channel transmissions. In some examples, the second one or more uplink control channel resources include PUCCH resources that are non-overlapping in time.

Additionally, or alternatively, the communications manager 1120 may support wireless communication at a UE in accordance with examples disclosed herein. The control message receiving component 1145 may be configured as or otherwise support a means for receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index. In some examples, the control message receiving component 1145 may be configured as or otherwise support a means for receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index.

In some examples, the PUCCH multiplexing component 1135 may be configured as or otherwise support a means for multiplexing the first set of multiple uplink control channel resources in accordance with one or more uplink multiplexing rules, where multiplexing the first set of multiple uplink control channel resources results in a first one or more uplink control channel resources. In some examples, the PUCCH multiplexing component 1135 may be configured as or otherwise support a means for multiplexing the second set of multiple uplink control channel resources in accordance with the one or more uplink multiplexing rules, where multiplexing the second set of multiple uplink control channel resources results in a second one or more uplink control channel resources. In some examples, the UCI transmitting component 1140 may be configured as or otherwise support a means for transmitting at least a portion of the first UCI on the first one or more uplink control channel resources and at least a portion of the second UCI on the second one or more uplink control channel resources.

In some examples, the control signal receiving component 1130 may be configured as or otherwise support a means for receiving a control signal that indicates an association between CORESET pool indices and uplink control channel resources available for transmission of scheduling requests or CSI.

In some examples, to support multiplexing the first set of multiple uplink control channel resources, the PUCCH multiplexing component 1135 may be configured as or otherwise support a means for selecting the first set of multiple uplink control channel resources for multiplexing based on an association between the first set of multiple uplink control channel resources and the first CORESET pool index.

In some examples, to support multiplexing the second set of multiple uplink control channel resources, the PUCCH multiplexing component 1135 may be configured as or otherwise support a means for selecting the second set of multiple uplink control channel resources for multiplexing based on an association between the second set of multiple uplink control channel resources and the second CORESET pool index.

In some examples, the indication receiving component 1125 may be configured as or otherwise support a means for receiving an indication of an association between unified TCI states and uplink control channel resources available for transmission of scheduling requests or CSI.

In some examples, to support multiplexing the first set of multiple uplink control channel resources, the PUCCH multiplexing component 1135 may be configured as or otherwise support a means for selecting the first set of multiple uplink control channel resources for multiplexing based on an association between the first set of multiple uplink control channel resources and a unified TCI state corresponding to the first CORESET pool index.

In some examples, to support multiplexing the second set of multiple uplink control channel resources, the PUCCH multiplexing component 1135 may be configured as or otherwise support a means for selecting the second set of multiple uplink control channel resources for multiplexing based on an association between the second set of multiple uplink control channel resources and a unified TCI state corresponding to the second CORESET pool index.

In some examples, the control signal receiving component 1130 may be configured as or otherwise support a means for receiving a control signal that indicates an association between closed loop indices and uplink control channel resources available for transmission of scheduling requests or CSI.

In some examples, to support multiplexing the first set of multiple uplink control channel resources, the PUCCH multiplexing component 1135 may be configured as or otherwise support a means for selecting the first set of multiple uplink control channel resources for multiplexing based on an association between the first set of multiple uplink control channel resources and a closed loop index corresponding to the first CORESET pool index.

In some examples, to support multiplexing the second set of multiple uplink control channel resources, the PUCCH multiplexing component 1135 may be configured as or otherwise support a means for selecting the second set of multiple uplink control channel resources for multiplexing based on an association between the second set of multiple uplink control channel resources and a closed loop index corresponding to the second CORESET pool index.

In some examples, the control signal receiving component 1130 may be configured as or otherwise support a means for receiving a control signal that indicates two or more CORESET pool indices configured for the UE, where multiplexing first set of multiple uplink control channel resources and the second set of multiple uplink control channel resources is based on the control signal.

In some examples, the control signal receiving component 1130 may be configured as or otherwise support a means for receiving a control signal that indicates a separate HARQ-ACK feedback mode for the UE, where multiplexing the first set of multiple uplink control channel resources separate from the second set of multiple uplink control channel resources is based on the control signal.

In some examples, the control signal receiving component 1130 may be configured as or otherwise support a means for receiving a control signal that indicates simultaneous uplink control channel transmissions are enabled for the UE, where transmitting the first UCI and the second UCI is based on the control signal.

In some examples, the control signal receiving component 1130 may be configured as or otherwise support a means for receiving a control signal that indicates a first one or more parameters associated with the first CORESET pool index and a second one or more parameters associated with the second CORESET pool index.

In some examples, to support multiplexing the first set of multiple uplink control channel resources, the PUCCH multiplexing component 1135 may be configured as or otherwise support a means for multiplexing the first set of multiple uplink control channel resources in accordance with the first one or more parameters associated with the first CORESET pool index.

In some examples, to support multiplexing the second set of multiple uplink control channel resources, the PUCCH multiplexing component 1135 may be configured as or otherwise support a means for multiplexing the second set of multiple uplink control channel resources in accordance with the second one or more parameters associated with the second CORESET pool index.

In some examples, the first one or more parameters define rules for multiplexing HARQ-ACK information and CSI associated with the first CORESET pool index. In some examples, the second one or more parameters define rules for multiplexing HARQ-ACK information and CSI associated with the second CORESET pool index. In some examples, transmitting the first UCI and the second UCI is based on a capability of the UE to support simultaneous uplink control channel transmissions.

In some examples, to support transmitting the first UCI and the second UCI, the UCI transmitting component 1140 may be configured as or otherwise support a means for transmitting the first UCI on the first one or more uplink control channel resources and the second UCI on the second one or more uplink control channel resources based on determining that the first one or more uplink control channel resources and the second one or more uplink control channel resources at least partially overlap in time. In some examples, the first one or more uplink control channel resources and the second one or more uplink control channel resources each include one or more PUCCH resources that are non-overlapping in time.

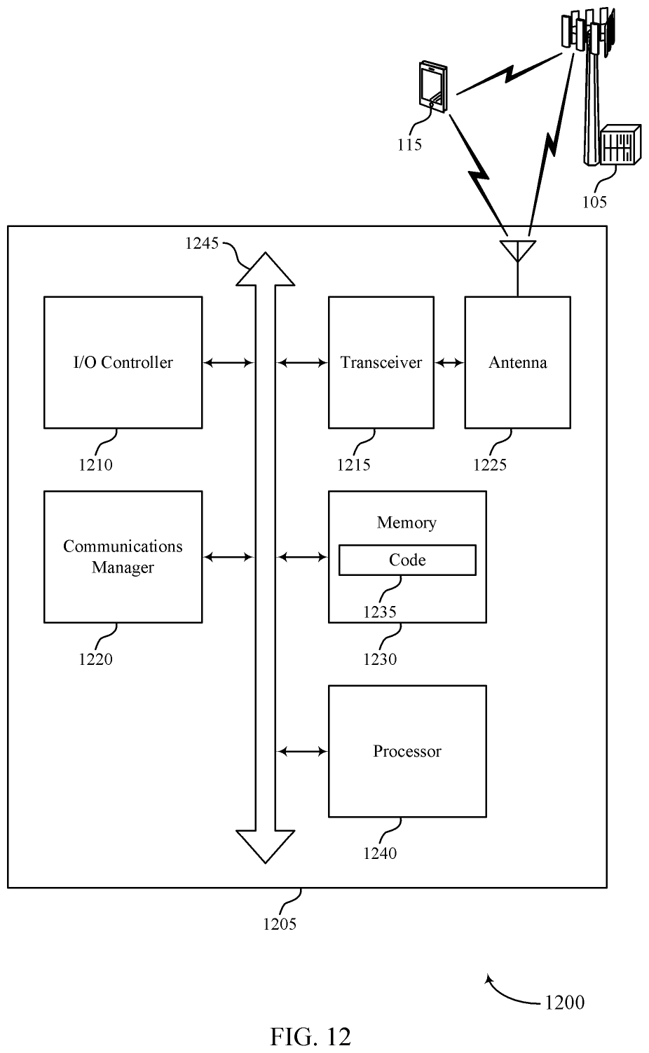

FIG. 12 shows a diagram of a system 1200 including a device 1205 that supports multiplexing techniques for simultaneous uplink control channel transmissions on a single CC in accordance with one or more aspects of the present disclosure. The device 1205 may be an example of or include the components of a device 905, a device 1005, or a UE 115, as described herein with reference to FIGS. 1 through 11. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links, as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting multiplexing techniques for simultaneous uplink control channel transmissions on a single CC). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communication at the device 1205 in accordance with examples disclosed herein. For example, the communications manager 1220 may be configured as or otherwise support a means for receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index. The communications manager 1220 may be configured as or otherwise support a means for receiving a control signal that schedules transmission of third UCI on a first one or more uplink control channel resources within the slot, where the third UCI includes scheduling information or CSI. The communications manager 1220 may be configured as or otherwise support a means for multiplexing the first uplink control channel resource with the first one or more uplink control channel resources in accordance with one or more uplink multiplexing rules, where the multiplexing results in a second one or more uplink control channel resources within the slot. The communications manager 1220 may be configured as or otherwise support a means for transmitting the first UCI, the second UCI, and at least a portion of the third UCI in the slot based on the multiplexing.

Additionally, or alternatively, the communications manager 1220 may support wireless communication at the device 1205 in accordance with examples disclosed herein. For example, the communications manager 1220 may be configured as or otherwise support a means for receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index. The communications manager 1220 may be configured as or otherwise support a means for receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index.

The communications manager 1220 may be configured as or otherwise support a means for multiplexing the first set of multiple uplink control channel resources in accordance with one or more uplink multiplexing rules, where multiplexing the first set of multiple uplink control channel resources results in a first one or more uplink control channel resources. The communications manager 1220 may be configured as or otherwise support a means for multiplexing the second set of multiple uplink control channel resources in accordance with the one or more uplink multiplexing rules, where multiplexing the second set of multiple uplink control channel resources results in a second one or more uplink control channel resources. The communications manager 1220 may be configured as or otherwise support a means for transmitting at least a portion of the first UCI on the first one or more uplink control channel resources and at least a portion of the second UCI on the second one or more uplink control channel resources.

By including or configuring the communications manager 1220 in accordance with examples, as described herein, the device 1205 may support techniques for improved UCI multiplexing operations. More specifically, the described techniques may enable the device 1205 to perform simultaneous PUCCH transmissions in accordance with a set of UCI multiplexing rules. For example, if the device 1205 is scheduled to transmit first HARQ-ACK feedback (associated with a first CORESET pool index) and second HARQ-ACK feedback (associated with a second CORESET pool index) on different PUCCH resources within a slot, the device 1205 may multiplex one or both of the first HARQ-ACK feedback or the second HARQ-ACK feedback with other UCI (e.g., CSI, scheduling requests), and may transmit both the first HARQ-ACK feedback and the second HARQ-ACK feedback within the slot, even if such transmissions overlap in time (at least to some extent). As a result, the device 1205 may attain higher throughput (by performing simultaneous PUCCH transmissions), reduced latency (by dropping fewer PUCCH transmissions), and greater spectral efficiency (by multiplexing the HARQ-ACK feedback with other UCI).

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of multiplexing techniques for simultaneous uplink control channel transmissions on a single CC, or the processor 1240 and the memory 1230 may be otherwise configured to perform or support such operations.

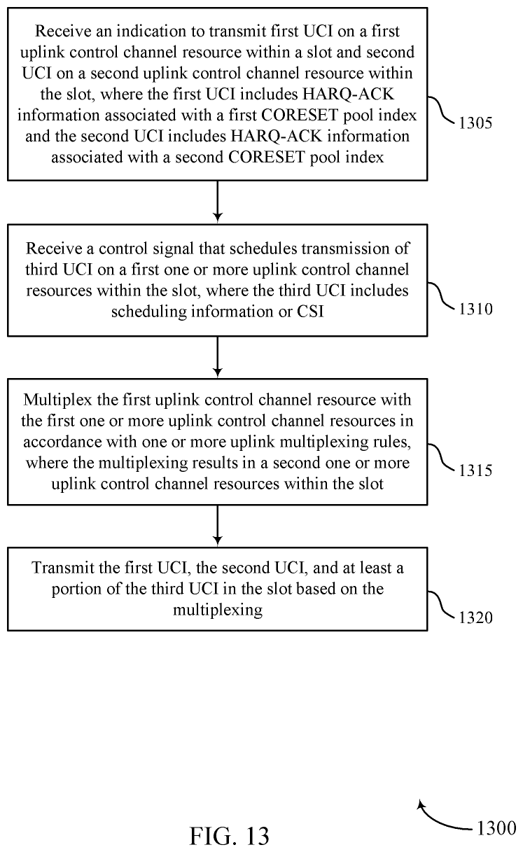

FIG. 13 shows a flowchart illustrating a method 1300 that supports multiplexing techniques for simultaneous uplink control channel transmissions on a single CC in accordance with one or more aspects of the present disclosure. The operations of the method 1300 may be implemented by a UE, as described herein with reference to FIGS. 1 through 12. For example, the operations of the method 1300 may be performed by a UE 115, as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index. The operations of 1305 may be performed in accordance with examples disclosed herein. In some examples, aspects of the operations of 1305 may be performed by an indication receiving component 1125, as described with reference to FIG. 11.

At 1310, the method may include receiving a control signal that schedules transmission of third UCI on a first one or more uplink control channel resources within the slot, where the third UCI includes scheduling information or CSI. The operations of 1310 may be performed in accordance with examples disclosed herein. In some examples, aspects of the operations of 1310 may be performed by a control signal receiving component 1130, as described with reference to FIG. 11.

At 1315, the method may include multiplexing the first uplink control channel resource with the first one or more uplink control channel resources in accordance with one or more uplink multiplexing rules, where the multiplexing results in a second one or more uplink control channel resources within the slot. The operations of 1315 may be performed in accordance with examples disclosed herein. In some examples, aspects of the operations of 1315 may be performed by a PUCCH multiplexing component 1135, as described with reference to FIG. 11.

At 1320, the method may include transmitting the first UCI, the second UCI, and at least a portion of the third UCI in the slot based on the multiplexing. The operations of 1320 may be performed in accordance with examples disclosed herein. In some examples, aspects of the operations of 1320 may be performed by a UCI transmitting component 1140, as described with reference to FIG. 11.

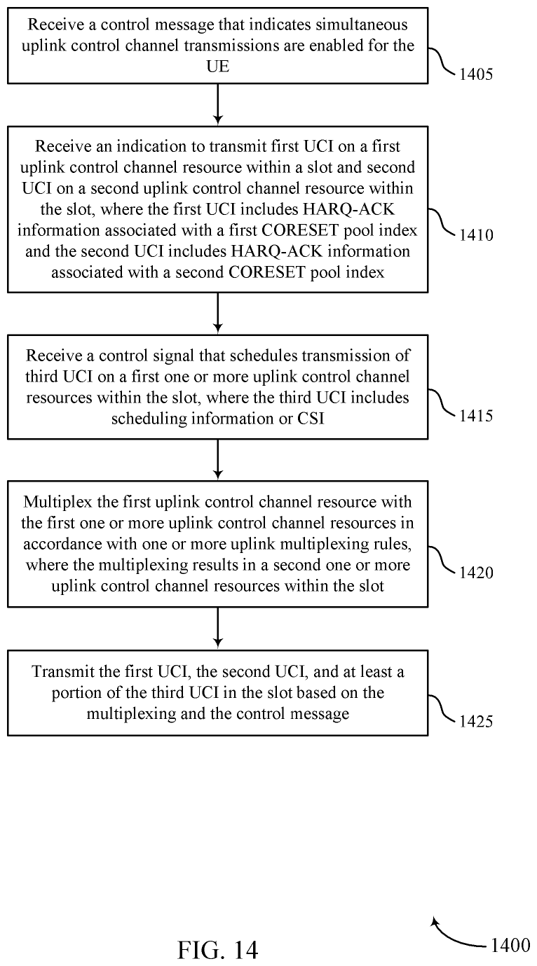

FIG. 14 shows a flowchart illustrating a method 1400 that supports multiplexing techniques for simultaneous uplink control channel transmissions on a single CC in accordance with one or more aspects of the present disclosure. The operations of the method 1400 may be implemented by a UE, as described herein with reference to FIGS. 1 through 12. For example, the operations of the method 1400 may be performed by a UE 115, as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving a control message that indicates simultaneous uplink control channel transmissions are enabled for the UE. The operations of 1405 may be performed in accordance with examples disclosed herein. In some examples, aspects of the operations of 1405 may be performed by a control message receiving component 1145, as described with reference to FIG. 11.

At 1410, the method may include receiving an indication to transmit first UCI on a first uplink control channel resource within a slot and second UCI on a second uplink control channel resource within the slot, where the first UCI includes HARQ-ACK information associated with a first CORESET pool index and the second UCI includes HARQ-ACK information associated with a second CORESET pool index. The operations of 1410 may be performed in accordance with examples disclosed herein. In some examples, aspects of the operations of 1410 may be performed by an indication receiving component 1125, as described with reference to FIG. 11.

At 1415, the method may include receiving a control signal that schedules transmission of third UCI on a first one or more uplink control channel resources within the slot, where the third UCI includes scheduling information or CSI. The operations of 1415 may be performed in accordance with examples disclosed herein. In some examples, aspects of the operations of 1415 may be performed by a control signal receiving component 1130, as described with reference to FIG. 11.

At 1420, the method may include multiplexing the first uplink control channel resource with the first one or more uplink control channel resources in accordance with one or more uplink multiplexing rules, where the multiplexing results in a second one or more uplink control channel resources within the slot. The operations of 1420 may be performed in accordance with examples disclosed herein. In some examples, aspects of the operations of 1420 may be performed by a PUCCH multiplexing component 1135, as described with reference to FIG. 11.

At 1425, the method may include transmitting the first UCI, the second UCI, and at least a portion of the third UCI in the slot based on the multiplexing and the control message. The operations of 1425 may be performed in accordance with examples disclosed herein. In some examples, aspects of the operations of 1425 may be performed by a UCI transmitting component 1140, as described with reference to FIG. 11.

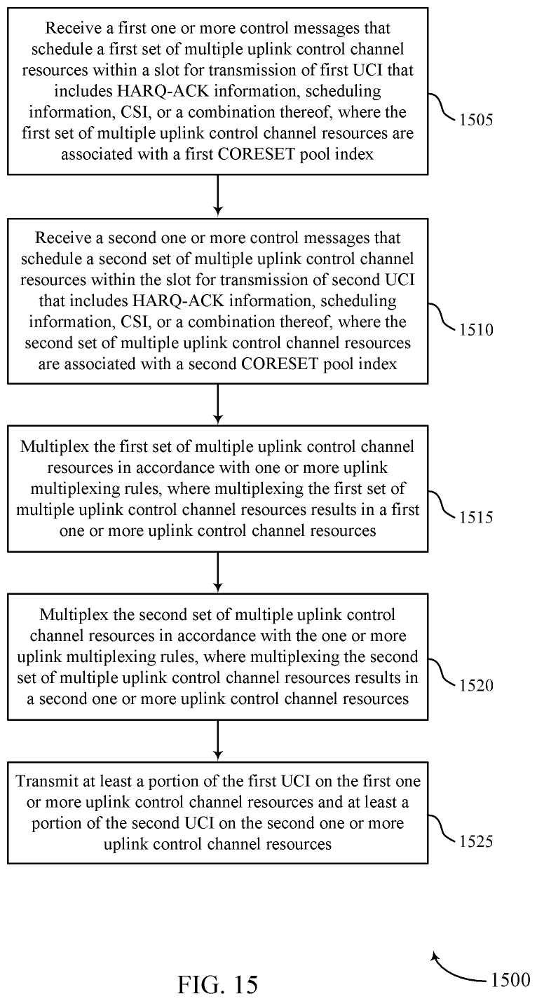

FIG. 15 shows a flowchart illustrating a method 1500 that supports multiplexing techniques for simultaneous uplink control channel transmissions on a single CC in accordance with one or more aspects of the present disclosure. The operations of the method 1500 may be implemented by a UE, as described herein with reference to FIGS. 1 through 12. For example, the operations of the method 1500 may be performed by a UE 115, as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index. The operations of 1505 may be performed in accordance with examples disclosed herein. In some examples, aspects of the operations of 1505 may be performed by a control message receiving component 1145, as described with reference to FIG. 11.

At 1510, the method may include receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index. The operations of 1510 may be performed in accordance with examples disclosed herein. In some examples, aspects of the operations of 1510 may be performed by a control message receiving component 1145, as described with reference to FIG. 11.

At 1515, the method may include multiplexing the first set of multiple uplink control channel resources in accordance with one or more uplink multiplexing rules, where multiplexing the first set of multiple uplink control channel resources results in a first one or more uplink control channel resources. The operations of 1515 may be performed in accordance with examples disclosed herein. In some examples, aspects of the operations of 1515 may be performed by a PUCCH multiplexing component 1135, as described with reference to FIG. 11.

At 1520, the method may include multiplexing the second set of multiple uplink control channel resources in accordance with the one or more uplink multiplexing rules, where multiplexing the second set of multiple uplink control channel resources results in a second one or more uplink control channel resources. The operations of 1520 may be performed in accordance with examples disclosed herein. In some examples, aspects of the operations of 1520 may be performed by a PUCCH multiplexing component 1135, as described with reference to FIG. 11.

At 1525, the method may include transmitting at least a portion of the first UCI on the first one or more uplink control channel resources and at least a portion of the second UCI on the second one or more uplink control channel resources. The operations of 1525 may be performed in accordance with examples disclosed herein. In some examples, aspects of the operations of 1525 may be performed by a UCI transmitting component 1140, as described with reference to FIG. 11.

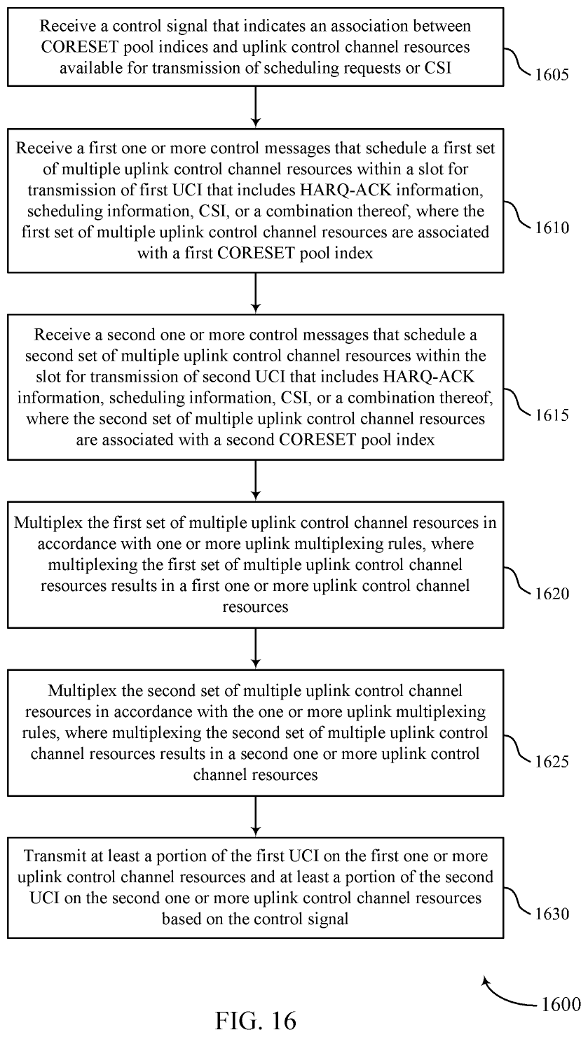

FIG. 16 shows a flowchart illustrating a method 1600 that supports multiplexing techniques for simultaneous uplink control channel transmissions on a single CC in accordance with one or more aspects of the present disclosure. The operations of the method 1600 may be implemented by a UE, as described herein with reference to FIGS. 1 through 12. For example, the operations of the method 1600 may be performed by a UE 115, as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1605, the method may include receiving a control signal that indicates an association between CORESET pool indices and uplink control channel resources available for transmission of scheduling requests or CSI. The operations of 1605 may be performed in accordance with examples disclosed herein. In some examples, aspects of the operations of 1605 may be performed by a control signal receiving component 1130, as described with reference to FIG. 11.

At 1610, the method may include receiving a first one or more control messages that schedule a first set of multiple uplink control channel resources within a slot for transmission of first UCI that includes HARQ-ACK information, scheduling information, CSI, or a combination thereof, where the first set of multiple uplink control channel resources are associated with a first CORESET pool index. The operations of 1610 may be performed in accordance with examples disclosed herein. In some examples, aspects of the operations of 1610 may be performed by a control message receiving component 1145, as described with reference to FIG. 11.

At 1615, the method may include receiving a second one or more control messages that schedule a second set of multiple uplink control channel resources within the slot for transmission of second UCI that includes HARQ-ACK information, scheduling information, CSI, or a combination thereof, where the second set of multiple uplink control channel resources are associated with a second CORESET pool index. The operations of 1615 may be performed in accordance with examples disclosed herein. In some examples, aspects of the operations of 1615 may be performed by a control message receiving component 1145, as described with reference to FIG. 11.

At 1620, the method may include multiplexing the first set of multiple uplink control channel resources in accordance with one or more uplink multiplexing rules, where multiplexing the first set of multiple uplink control channel resources results in a first one or more uplink control channel resources. The operations of 1620 may be performed in accordance with examples disclosed herein. In some examples, aspects of the operations of 1620 may be performed by a PUCCH multiplexing component 1135, as described with reference to FIG. 11.

At 1625, the method may include multiplexing the second set of multiple uplink control channel resources in accordance with the one or more uplink multiplexing rules, where multiplexing the second set of multiple uplink control channel resources results in a second one or more uplink control channel resources. The operations of 1625 may be performed in accordance with examples disclosed herein. In some examples, aspects of the operations of 1625 may be performed by a PUCCH multiplexing component 1135, as described with reference to FIG. 11.

At 1630, the method may include transmitting at least a portion of the first UCI on the first one or more uplink control channel resources and at least a portion of the second UCI on the second one or more uplink control channel resources based on the control signal. The operations of 1630 may be performed in accordance with examples disclosed herein. In some examples, aspects of the operations of 1630 may be performed by a UCI transmitting component 1140, as described with reference to FIG. 11.

The following provides an overview of aspects of the present disclosure:

Aspect 1: A method for wireless communication at a UE, comprising: receiving an indication to transmit first uplink control information on a first uplink control channel resource within a slot and second uplink control information on a second uplink control channel resource within the slot, wherein the first uplink control information comprises hybrid automatic repeat request acknowledgement information associated with a first control resource set pool index and the second uplink control information comprises hybrid automatic repeat request acknowledgement information associated with a second control resource set pool index; receiving a control signal that schedules transmission of third uplink control information on a first one or more uplink control channel resources within the slot, wherein the third uplink control information comprises scheduling information or channel state information; multiplexing the first uplink control channel resource with the first one or more uplink control channel resources in accordance with one or more uplink multiplexing rules, wherein the multiplexing results in a second one or more uplink control channel resources within the slot; and transmitting the first uplink control information, the second uplink control information, and at least a portion of the third uplink control information in the slot based at least in part on the multiplexing.

Aspect 2: The method of aspect 1, wherein the second uplink control channel resource is excluded from the multiplexing based at least in part on the second control resource set pool index having a fixed value.

Aspect 3: The method of any of aspects 1 through 2, wherein the second uplink control channel resource is excluded from the multiplexing based at least in part on a time duration of the second uplink control channel resource starting prior to a time duration of the first uplink control channel resource.

Aspect 4: The method of any of aspects 1 through 3, wherein the second uplink control channel resource is excluded from the multiplexing based at least in part on a time duration of the second uplink control channel resource starting after a time duration of the first uplink control channel resource.

Aspect 5: The method of any of aspects 1 through 4, wherein transmitting the first uplink control information, the second uplink control information, and at least a portion of the third uplink control information comprises: transmitting the second uplink control information on the second uplink control channel resource; and transmitting one or both of the first uplink control information or the third uplink control information on the second one or more uplink control channel resources based at least in part on determining that the second uplink control channel resource and the second one or more uplink control channel resources are non-overlapping in time.

Aspect 6: The method of any of aspects 1 through 5, wherein a first portion of the second one or more uplink control channel resources corresponds to the hybrid automatic repeat request acknowledgement information associated with the first control resource set pool index, a first portion of the third uplink control information, or both; and a second portion of the second one or more uplink control channel resources corresponds to a second portion of the third uplink control information.

Aspect 7: The method of aspect 6, wherein transmitting the first uplink control information, the second uplink control information, and at least a portion of the third uplink control information comprises: transmitting the second uplink control information on the second uplink control channel resource; transmitting one or both of the first uplink control information or the first portion of the third uplink control information on the first portion of the second one or more uplink control channel resources; and transmitting the second portion of the third uplink control information on the second portion of the second one or more uplink control channel resources based at least in part on determining that the second uplink control channel resource and the second portion of the second one or more uplink control channel resources are non-overlapping in time.

Aspect 8: The method of any of aspects 6 through 7, further comprising: dropping the second portion of the second one or more uplink control channel resources based at least in part on determining that the second uplink control channel resource and the second portion of the second one or more uplink control channel resources at least partially overlap in time.

Aspect 9: The method of aspect 8, wherein transmitting the first uplink control information, the second uplink control information, and at least a portion of the third uplink control information comprises: transmitting the second uplink control information on the second uplink control channel resource; transmitting one or both of the first uplink control information or the first portion of the third uplink control information on the first portion of the second one or more uplink control channel resources; refraining from transmitting the second portion of the third uplink control information based at least in part on dropping the second portion of the second one or more uplink control channel resources; and transmitting a third portion of the third uplink control information on a third portion of the second one or more uplink control channel resources based at least in part on determining that the second uplink control channel resource and the third portion of the second one or more uplink control channel resources are non-overlapping in time.

Aspect 10: The method of any of aspects 6 through 9, further comprising: multiplexing the second uplink control channel resource with the second portion of the second one or more uplink control channel resources based at least in part on determining that the second uplink control channel resource and the second portion of the second one or more uplink control channel resources at least partially overlap in time.

Aspect 11: The method of aspect 10, wherein transmitting the first uplink control information, the second uplink control information, and at least a portion of the third uplink control information comprises: transmitting the second uplink control information and the second portion of the third uplink control information on the second uplink control channel resource or a third uplink control channel resource that is different from the second uplink control channel resource based at least in part on multiplexing the second uplink control channel resource with the second portion of the second one or more uplink control channel resources; transmitting one or both of the first uplink control information or the first portion of the third uplink control information on the first portion of the second one or more uplink control channel resources; and transmitting a third portion of the third uplink control information on a third portion of the second one or more uplink control channel resources based at least in part on determining that the second uplink control channel resource and the third portion of the second one or more uplink control channel resources are non-overlapping in time.

Aspect 12: The method of any of aspects 1 through 11, further comprising: receiving a control message that indicates a separate hybrid automatic repeat request acknowledgement feedback mode for the UE, wherein the second uplink control channel resource is excluded from the multiplexing based at least in part on the separate hybrid automatic repeat request acknowledgement feedback mode of the UE.

Aspect 13: The method of any of aspects 1 through 12, further comprising: receiving a control message that indicates simultaneous uplink control channel transmissions are enabled for the UE, wherein transmitting the first uplink control information, the second uplink control information, and at least a portion of the third uplink control information is based at least in part on the control message.

Aspect 14: The method of any of aspects 1 through 13, further comprising: receiving a control message that indicates a first one or more parameters associated with the first control resource set pool index and a second one or more parameters associated with the second control resource set pool index, wherein multiplexing the first uplink control channel resource with the first one or more uplink control channel resources is based at least in part on the first one or more parameters.

Aspect 15: The method of aspect 14, wherein the first one or more parameters define rules for multiplexing channel state information with hybrid automatic repeat request acknowledgement information associated with the first control resource set pool index; and the second one or more parameters define rules for multiplexing channel state information with hybrid automatic repeat request acknowledgement information associated with the second control resource set pool index.

Aspect 16: The method of any of aspects 1 through 15, wherein transmitting the first uplink control information, the second uplink control information, and at least a portion of the third uplink control information is based at least in part on a capability of the UE to support simultaneous uplink control channel transmissions.

Aspect 17: The method of any of aspects 1 through 16, wherein the second one or more uplink control channel resources comprise PUCCH resources that are non-overlapping in time.

Aspect 18: A method for wireless communication at a UE, comprising: receiving a first one or more control messages that schedule a first plurality of uplink control channel resources within a slot for transmission of first uplink control information that comprises hybrid automatic repeat request acknowledgement information, scheduling information, channel state information, or a combination thereof, wherein the first plurality of uplink control channel resources are associated with a first control resource set pool index; receiving a second one or more control messages that schedule a second plurality of uplink control channel resources within the slot for transmission of second uplink control information that comprises hybrid automatic repeat request acknowledgement information, scheduling information, channel state information, or a combination thereof, wherein the second plurality of uplink control channel resources are associated with a second control resource set pool index; multiplexing the first plurality of uplink control channel resources in accordance with one or more uplink multiplexing rules, wherein multiplexing the first plurality of uplink control channel resources results in a first one or more uplink control channel resources; multiplexing the second plurality of uplink control channel resources in accordance with the one or more uplink multiplexing rules, wherein multiplexing the second plurality of uplink control channel resources results in a second one or more uplink control channel resources; and transmitting at least a portion of the first uplink control information on the first one or more uplink control channel resources and at least a portion of the second uplink control information on the second one or more uplink control channel resources.

Aspect 19: The method of aspect 18, further comprising: receiving a control signal that indicates an association between control resource set pool indices and uplink control channel resources available for transmission of scheduling requests or channel state information.

Aspect 20: The method of any of aspects 18 through 19, wherein multiplexing the first plurality of uplink control channel resources comprises: selecting the first plurality of uplink control channel resources for multiplexing based at least in part on an association between the first plurality of uplink control channel resources and the first control resource set pool index.

Aspect 21: The method of any of aspects 18 through 20, wherein multiplexing the second plurality of uplink control channel resources comprises: selecting the second plurality of uplink control channel resources for multiplexing based at least in part on an association between the second plurality of uplink control channel resources and the second control resource set pool index.

Aspect 22: The method of any of aspects 18 through 21, further comprising: receiving an indication of an association between unified transmission configuration indicator states and uplink control channel resources available for transmission of scheduling requests or channel state information.

Aspect 23: The method of any of aspects 18 through 22, wherein multiplexing the first plurality of uplink control channel resources comprises: selecting the first plurality of uplink control channel resources for multiplexing based at least in part on an association between the first plurality of uplink control channel resources and a unified transmission configuration indicator state corresponding to the first control resource set pool index.

Aspect 24: The method of any of aspects 18 through 23, wherein multiplexing the second plurality of uplink control channel resources comprises: selecting the second plurality of uplink control channel resources for multiplexing based at least in part on an association between the second plurality of uplink control channel resources and a unified transmission configuration indicator state corresponding to the second control resource set pool index.

Aspect 25: The method of any of aspects 18 through 24, further comprising: receiving a control signal that indicates an association between closed loop indices and uplink control channel resources available for transmission of scheduling requests or channel state information.

Aspect 26: The method of any of aspects 18 through 25, wherein multiplexing the first plurality of uplink control channel resources comprises: selecting the first plurality of uplink control channel resources for multiplexing based at least in part on an association between the first plurality of uplink control channel resources and a closed loop index corresponding to the first control resource set pool index.

Aspect 27: The method of any of aspects 18 through 26, wherein multiplexing the second plurality of uplink control channel resources comprises: selecting the second plurality of uplink control channel resources for multiplexing based at least in part on an association between the second plurality of uplink control channel resources and a closed loop index corresponding to the second control resource set pool index.

Aspect 28: The method of any of aspects 18 through 27, further comprising: receiving a control signal that indicates two or more control resource set pool indices configured for the UE, wherein multiplexing first plurality of uplink control channel resources and the second plurality of uplink control channel resources is based at least in part on the control signal.

Aspect 29: The method of any of aspects 18 through 28, further comprising: receiving a control signal that indicates a separate hybrid automatic repeat request acknowledgement feedback mode for the UE, wherein multiplexing the first plurality of uplink control channel resources separate from the second plurality of uplink control channel resources is based at least in part on the control signal.

Aspect 30: The method of any of aspects 18 through 29, further comprising: receiving a control signal that indicates simultaneous uplink control channel transmissions are enabled for the UE, wherein transmitting the first uplink control information and the second uplink control information is based at least in part on the control signal.

Aspect 31: The method of any of aspects 18 through 30, further comprising: receiving a control signal that indicates a first one or more parameters associated with the first control resource set pool index and a second one or more parameters associated with the second control resource set pool index.

Aspect 32: The method of aspect 31, wherein multiplexing the first plurality of uplink control channel resources comprises: multiplexing the first plurality of uplink control channel resources in accordance with the first one or more parameters associated with the first control resource set pool index.

Aspect 33: The method of any of aspects 31 through 32, wherein multiplexing the second plurality of uplink control channel resources comprises: multiplexing the second plurality of uplink control channel resources in accordance with the second one or more parameters associated with the second control resource set pool index.

Aspect 34: The method of any of aspects 31 through 33, wherein the first one or more parameters define rules for multiplexing hybrid automatic repeat request acknowledgement information and channel state information associated with the first control resource set pool index; and the second one or more parameters define rules for multiplexing hybrid automatic repeat request acknowledgement information and channel state information associated with the second control resource set pool index.

Aspect 35: The method of any of aspects 18 through 34, wherein transmitting the first uplink control information and the second uplink control information is based at least in part on a capability of the UE to support simultaneous uplink control channel transmissions.

Aspect 36: The method of any of aspects 18 through 35, wherein transmitting the first uplink control information and the second uplink control information comprises: transmitting the first uplink control information on the first one or more uplink control channel resources and the second uplink control information on the second one or more uplink control channel resources based at least in part on determining that the first one or more uplink control channel resources and the second one or more uplink control channel resources at least partially overlap in time.

Aspect 37: The method of any of aspects 18 through 36, wherein the first one or more uplink control channel resources and the second one or more uplink control channel resources each comprise one or more PUCCH resources that are non-overlapping in time.

Aspect 38: An apparatus for wireless communication at a UE, comprising a processor; memory coupled with the processor; and one or more instructions stored in the memory and executable by the processor to cause the apparatus to, based at least in part on the one or more instructions, perform a method of any of aspects 1 through 17.

Aspect 39: An apparatus for wireless communication at a UE, comprising at least one means for performing a method of any of aspects 1 through 17.

Aspect 40: A non-transitory computer-readable medium storing code for wireless communication at a UE, the code comprising instructions executable by a processor to perform a method of any of aspects 1 through 17.

Aspect 41: An apparatus for wireless communication at a UE, comprising a processor; memory coupled with the processor; and one or more instructions stored in the memory and executable by the processor to cause the apparatus to, based at least in part on the one or more instructions, perform a method of any of aspects 18 through 37.

Aspect 42: An apparatus for wireless communication at a UE, comprising at least one means for performing a method of any of aspects 18 through 37.

Aspect 43: A non-transitory computer-readable medium storing code for wireless communication at a UE, the code comprising instructions executable by a processor to perform a method of any of aspects 18 through 37.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the terms “set,” and “one or more” shall be construed in the same manner.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-17. (canceled)

18. A method for wireless communication at a user equipment (UE), comprising:
receiving a first one or more control messages that schedule a first plurality of uplink control channel resources within a slot for transmission of first uplink control information that comprises hybrid automatic repeat request acknowledgement information, scheduling information, channel state information, or a combination thereof, wherein the first plurality of uplink control channel resources are associated with a first control resource set pool index;
receiving a second one or more control messages that schedule a second plurality of uplink control channel resources within the slot for transmission of second uplink control information that comprises hybrid automatic repeat request acknowledgement information, scheduling information, channel state information, or a combination thereof, wherein the second plurality of uplink control channel resources are associated with a second control resource set pool index;
multiplexing the first plurality of uplink control channel resources in accordance with one or more uplink multiplexing rules, wherein multiplexing the first plurality of uplink control channel resources results in a first one or more uplink control channel resources;
multiplexing the second plurality of uplink control channel resources in accordance with the one or more uplink multiplexing rules, wherein multiplexing the second plurality of uplink control channel resources results in a second one or more uplink control channel resources; and
transmitting at least a portion of the first uplink control information on the first one or more uplink control channel resources and at least a portion of the second uplink control information on the second one or more uplink control channel resources.

19. The method of claim 18, further comprising:
receiving a control signal that indicates an association between control resource set pool indices and uplink control channel resources available for transmission of scheduling requests or channel state information.

20. The method of claim 18, wherein multiplexing the first plurality of uplink control channel resources comprises:
selecting the first plurality of uplink control channel resources for multiplexing based at least in part on an association between the first plurality of uplink control channel resources and the first control resource set pool index.

21. The method of claim 18, wherein multiplexing the second plurality of uplink control channel resources comprises:
selecting the second plurality of uplink control channel resources for multiplexing based at least in part on an association between the second plurality of uplink control channel resources and the second control resource set pool index.

22. The method of claim 18, further comprising:
receiving an indication of an association between unified transmission configuration indicator states and uplink control channel resources available for transmission of scheduling requests or channel state information.

23. The method of claim 18, wherein multiplexing the first plurality of uplink control channel resources comprises:
selecting the first plurality of uplink control channel resources for multiplexing based at least in part on an association between the first plurality of uplink control channel resources and a unified transmission configuration indicator state corresponding to the first control resource set pool index.

24. The method of claim 18, wherein multiplexing the second plurality of uplink control channel resources comprises:
selecting the second plurality of uplink control channel resources for multiplexing based at least in part on an association between the second plurality of uplink control channel resources and a unified transmission configuration indicator state corresponding to the second control resource set pool index.

25. The method of claim 18, further comprising:
receiving a control signal that indicates an association between closed loop indices and uplink control channel resources available for transmission of scheduling requests or channel state information.

26. The method of claim 18, wherein multiplexing the first plurality of uplink control channel resources comprises:
selecting the first plurality of uplink control channel resources for multiplexing based at least in part on an association between the first plurality of uplink control channel resources and a closed loop index corresponding to the first control resource set pool index.

27. The method of claim 18, wherein multiplexing the second plurality of uplink control channel resources comprises:
selecting the second plurality of uplink control channel resources for multiplexing based at least in part on an association between the second plurality of uplink control channel resources and a closed loop index corresponding to the second control resource set pool index.

28. The method of claim 18, further comprising:
receiving a control signal that indicates two or more control resource set pool indices configured for the UE, wherein multiplexing the first plurality of uplink control channel resources and the second plurality of uplink control channel resources is based at least in part on the control signal.

29. The method of claim 18, further comprising:
receiving a control signal that indicates a separate hybrid automatic repeat request acknowledgement feedback mode for the UE, wherein multiplexing the first plurality of uplink control channel resources separate from the second plurality of uplink control channel resources is based at least in part on the control signal.

30. The method of claim 18, further comprising:
receiving a control signal that indicates simultaneous uplink control channel transmissions are enabled for the UE, wherein transmitting the first uplink control information and the second uplink control information is based at least in part on the control signal.

31. The method of claim 18, further comprising:
receiving a control signal that indicates a first one or more parameters associated with the first control resource set pool index and a second one or more parameters associated with the second control resource set pool index, wherein the first plurality of uplink control channel resources is multiplexed in accordance with the first one or more parameters, and wherein the second plurality of uplink control channel resources is multiplexed in accordance with the second one or more parameters.

32-33. (canceled)

34. The method of claim 31, wherein:
the first one or more parameters define rules for multiplexing hybrid automatic repeat request acknowledgement information and channel state information associated with the first control resource set pool index; and
the second one or more parameters define rules for multiplexing hybrid automatic repeat request acknowledgement information and channel state information associated with the second control resource set pool index.

35. The method of claim 18, wherein transmitting the first uplink control information and the second uplink control information is based at least in part on a capability of the UE to support simultaneous uplink control channel transmissions.

36. The method of claim 18, wherein transmitting the first uplink control information and the second uplink control information comprises:
transmitting the first uplink control information on the first one or more uplink control channel resources and the second uplink control information on the second one or more uplink control channel resources based at least in part on determining that the first one or more uplink control channel resources and the second one or more uplink control channel resources at least partially overlap in time.

37. The method of claim 18, wherein the first one or more uplink control channel resources and the second one or more uplink control channel resources each comprise one or more physical uplink control channel (PUCCH) resources that are non-overlapping in time.

38. (canceled)

39. A user equipment (UE) for wireless communication, comprising:
one or more memories storing processor-executable code; and
one or more processors coupled with the one or more memories and operable to execute the code to cause the UE to:
receive a first one or more control messages that schedule a first plurality of uplink control channel resources within a slot for transmission of first uplink control information that comprises hybrid automatic repeat request acknowledgement information, scheduling information, channel state information, or a combination thereof, wherein the first plurality of uplink control channel resources are associated with a first control resource set pool index;
receive a second one or more control messages that schedule a second plurality of uplink control channel resources within the slot for transmission of second uplink control information that comprises hybrid automatic repeat request acknowledgement information, scheduling information, channel state information, or a combination thereof, wherein the second plurality of uplink control channel resources are associated with a second control resource set pool index;
multiplex the first plurality of uplink control channel resources in accordance with one or more uplink multiplexing rules, wherein multiplexing the first plurality of uplink control channel resources results in a first one or more uplink control channel resources;
multiplex the second plurality of uplink control channel resources in accordance with the one or more uplink multiplexing rules, wherein multiplexing the second plurality of uplink control channel resources results in a second one or more uplink control channel resources; and
transmit at least a portion of the first uplink control information on the first one or more uplink control channel resources and at least a portion of the second uplink control information on the second one or more uplink control channel resources.

40. (canceled)

41. A user equipment (UE) for wireless communication, comprising:
means for receiving a first one or more control messages that schedule a first plurality of uplink control channel resources within a slot for transmission of first uplink control information that comprises hybrid automatic repeat request acknowledgement information, scheduling information, channel state information, or a combination thereof, wherein the first plurality of uplink control channel resources are associated with a first control resource set pool index;
means for receiving a second one or more control messages that schedule a second plurality of uplink control channel resources within the slot for transmission of second uplink control information that comprises hybrid automatic repeat request acknowledgement information, scheduling information, channel state information, or a combination thereof, wherein the second plurality of uplink control channel resources are associated with a second control resource set pool index;
means for multiplexing the first plurality of uplink control channel resources in accordance with one or more uplink multiplexing rules, wherein multiplexing the first plurality of uplink control channel resources results in a first one or more uplink control channel resources;
means for multiplexing the second plurality of uplink control channel resources in accordance with the one or more uplink multiplexing rules, wherein multiplexing the second plurality of uplink control channel resources results in a second one or more uplink control channel resources; and
means for transmitting at least a portion of the first uplink control information on the first one or more uplink control channel resources and at least a portion of the second uplink control information on the second one or more uplink control channel resources.

42-43. (canceled)
